(19) United States
(12) Patent Application Publication
(10) Pub. No.: US 2017/0290645 A1
(43) Pub. Date: Oct. 12, 2017

(54) FIXATION SYSTEM

(71) Applicant: EdMiDent, LLC, Los Angeles, CA (US)

(72) Inventor: Edwin Rostami, Yerevan (AM)

(21) Appl. No.: 15/486,184

(22) Filed: Apr. 12, 2017

Related U.S. Application Data
(60) Provisional application No. 62/321,696, filed on Apr. 12, 2016.

(51) Int. Cl. A61C 8/00; A61C 8/02

(52) U.S. Cl. CPC A61C 8/0031; A61C 8/0006; A61C 8/0025

(57) ABSTRACT

A fixation facilitator mechanically associated with an intraosseous dental implant fixture.

### CROSS-REFERENCE TO RELATED APPLICATIONS

This Application claims the benefit of priority of co-pending U.S. Utility Provisional Patent Application 62/321,696, filed Apr. 12, 2016, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

### Field of the Invention

One or more embodiments of the present invention relate to the general field of medicine and bone implants, more specifically dental implants for use in oral and maxillofacial surgery and, more particularly to a fixation system for intraosseous dental implants universally applicable at an implantation site on the mandible or the maxilla.

### Description of Related Art

Conventional support mechanisms for intraosseous dental implants are well known and have been in use for a number of years. Non-limiting examples of support mechanisms for intraosseous dental implants are disclosed in U.S. Patent Application Publication 2014/0248583 to Rostami, the entire disclosure of which application is expressly incorporated by reference herein in its entirety.

In general, the support mechanisms include connection sections that must be bent commensurate in shape with the curvature of the implant site prior to mounting and securing onto a jawbone, which may result in sharp angled edges (generally near the fixture hole) due to human error rather than a smooth curve that substantially matches the topography of the implant site. This mismatch due to sharp bend generates void space in between the support mechanism and the implant site, impeding osseointegration. Further, the generated sharp angle may sever surrounding soft tissues (e.g., the gingiva), resulting in an open wound that may cause infection or generation of granulated tissues.

Further, known support mechanisms include a fixture hole that is threaded (female threading), corresponding to male threading of a specific type, make, and model of the intraosseous dental implant fixture. That is, the female threading of the fixture hole on known support mechanisms is specifically configured and particularly adapted to correspondingly match and to detachably receive and mate with the correspondingly matched (i.e., complementary) male threading of the specific type, make, and model of the intraosseous dental implant fixture. This enables the use of the known support mechanism with any particular intraosseous dental implant fixture without modifying the intraosseous dental implant fixtures. However, this also requires that the threading of the fixture hole for each support mechanism to be configured and adapted for each type, make, and model of the intraosseous dental implant fixture. In other words, since there are several different types, makes, and models of the intraosseous dental implant fixtures, with each having different types of threading, then several different types of support mechanisms with corresponding female threading of fixture hole must be produced, which adds to the cost of manufacturing the support mechanism.

Additionally, known support mechanisms work well if the gingiva tissue (the gum) at the implant heals properly. That is, osseointegration is achieved with no bone resorption. However, in certain instances where the gingiva tissue at the implant site does not properly heal, osseointegration with the connection sections of the support mechanism is not achieved.

Accordingly, in light of the current state of the art and the drawbacks to current support mechanisms mentioned above, a need exists for a pre-curved fixation system that does not require substantial bending of the connection sections. Further, a need exists for a fixation system that may be universally used with different types, makes, and models of existing intraosseous dental implant fixtures. Additionally, a need exists for a fixation system that would enhance osseointegration of the fixation system and its associated intraosseous dental implant fixture with the implant site.

### BRIEF SUMMARY OF THE INVENTION

A non-limiting, exemplary aspect of an embodiment of the present invention provides a fixation system, comprising:

a fixation plate that includes a first side and a second side;

a hole associated with the fixation plate;

a reinforcement member associated with the hole;

an aperture for securing the fixation plate with a bone;

an orifice for integration of the fixation plate with the bone; and

a fixation facilitator associated with the reinforcement member.

Another non-limiting, exemplary aspect of an embodiment of the present invention provides a dental implant fixation system, comprising:

a fixation plate that includes a first side and a second side;

a hole associated with the fixation plate;

a reinforcement member associated with the hole;

an aperture for securing the fixation plate with a bone;

an orifice for integration of the fixation plate with the bone;

a fixation facilitator associated with the reinforcement member; and

an intraosseous dental implant fixture secured to the fixation facilitator.

Still another non-limiting, exemplary aspect of an embodiment of the present invention provides an intraosseous dental implant fixture assembly, comprising:

an intraosseous dental implant fixture; and

a fixation facilitator mechanically secured onto the intraosseous dental implant fixture.

A further non-limiting, exemplary aspect of an embodiment of the present invention provides a fixation facilitator, comprising:

an inner configuration commensurate with an implantation site of a bone structure, outer configuration commensurate with adjacent sites of the bone structure;

wherein: an intraosseous dental implant fixture secures fixation facilitator onto an implantation site without the use of fasteners.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 11 are non-limiting, exemplary illustrations of a fixation system in accordance with one or more embodiments of the present invention;

FIGS. 12A to 12I are non-limiting, exemplary illustrations of a fixation system in accordance with one or more embodiments of the present invention; and

FIGS. 13A to 13H are non-limiting, exemplary illustrations of a fixation system in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

Throughout the disclosure, any references to any human anatomy are meant as an illustrative, convenient example for discussion purposes only. That is, the use and application of the various embodiments of the apparatus of the present invention should not be limited to humans but may also be applicable and used in animals, non-limiting examples of which may include dogs, cats, etc.

It should be noted that throughout the disclosure of the present invention, the use of terms such as “opening,” “orifice,” “hole,” “aperture” or equivalents thereof refer to the same type of structure: an opening (a “through-opening”). The applicant elected to use various synonyms for the term “opening” for an easier read of the specification and claims. Accordingly, the terms opening, hole, orifice, aperture, etc. may be construed as simply “through-opening” with its plane and ordinary meaning (i.e., opening, hole, aperture, orifice, etc.) as evident from the description and the accompanying drawings of the present invention, which refer to and show the same type of construct for all: a pass through opening (or “through-opening”).

Further, in the description given below and the corresponding set of drawing figures, when it is necessary to distinguish the various members, elements, sections/portions, components, parts, or any other aspects (functional or otherwise) or features of a device(s) or method(s) from each other, the description and the corresponding drawing figures may follow reference numbers with a lowercase alphabet character such as (for example) “fixation plate 100a, 100b, etc.” If the description is common to all of the various members, elements, sections/portions, components, parts, or any other aspects (functional or otherwise) or features of a device(s) or method(s) such as, for example, to all fixation plates 100a, 100b, etc., then they may simply be referred to with reference number only and with no alphabet character such as, for example, “fixation plate 100.”

One or more embodiments of the present invention provide fixation systems that have curved connection sections and hence, do not require substantial bending for mounting onto an implantation site. Further, one or more embodiments of the present invention provide fixation systems that may be universally used with different types, makes, and models of existing intraosseous dental implant fixtures. Additionally, one or more embodiments of the present invention provide fixation systems that enhance osseointegration of the fixation system and its associated intraosseous dental implant fixtures with the implant site.

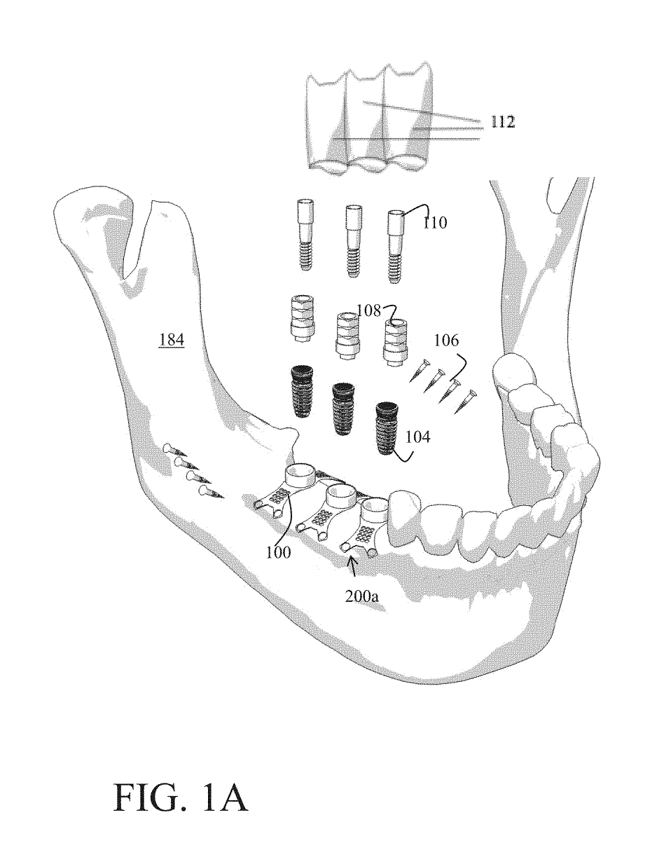

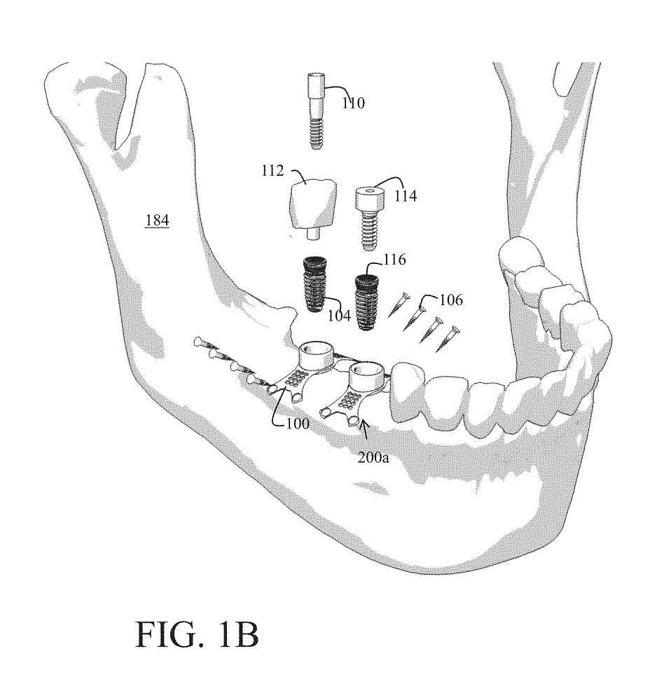

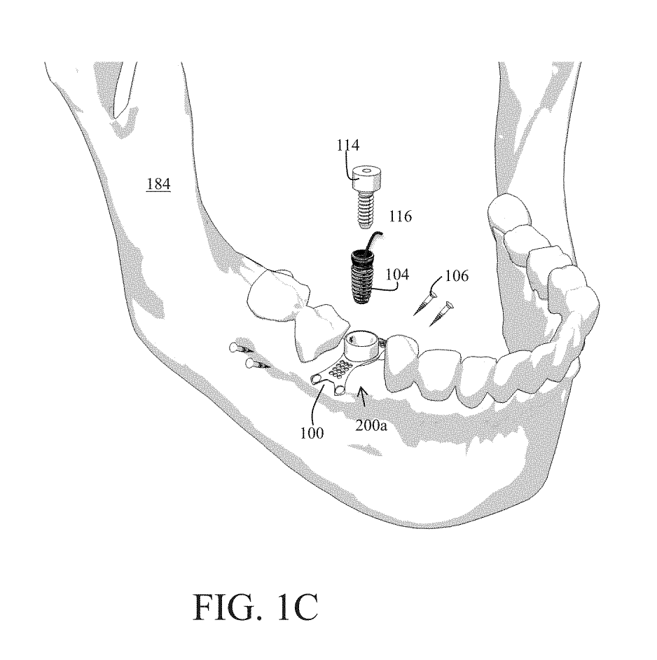

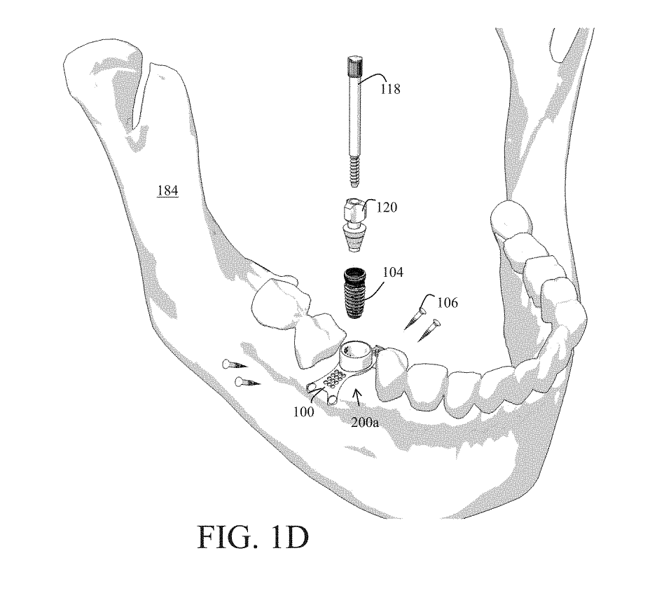

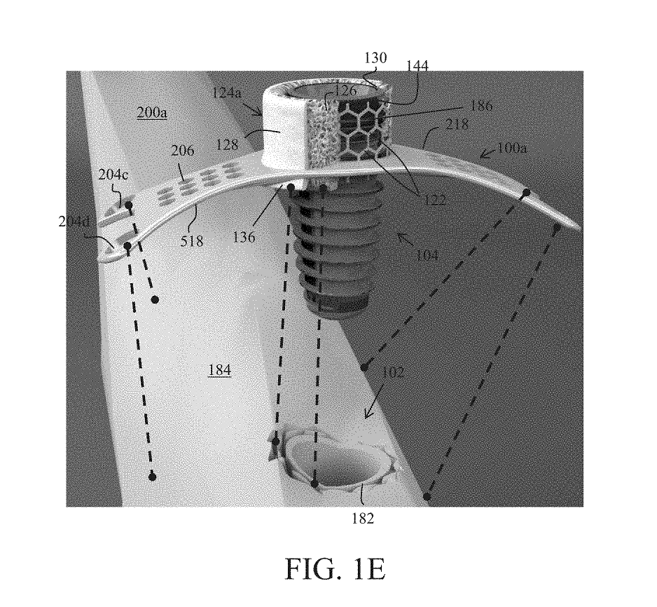

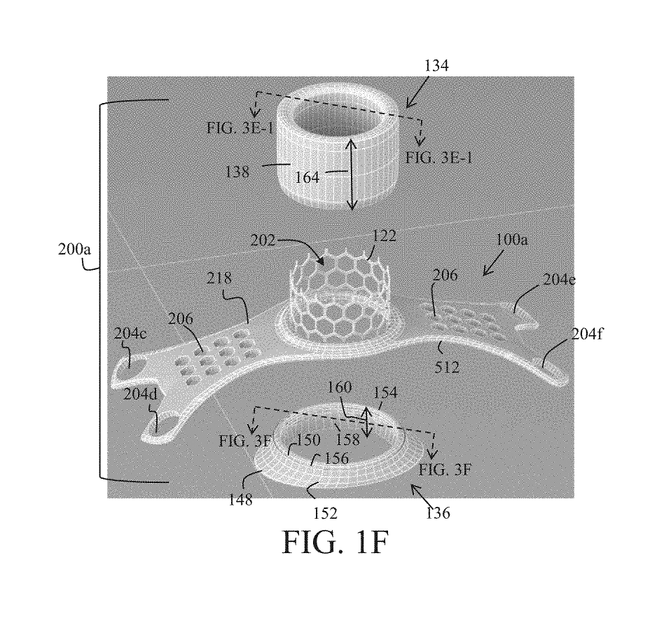

Embodiments of the fixation systems illustrated in FIGS. 1A to 10 provide a fixation system 200a with fixation plates 100, which forms a base, foundation, or an anchoring support on upper or lower jawbone accommodating a non-limiting, exemplary intraosseous dental implant fixture 104 to form a strong, stable load bearing support that reduces parafunctional stress on implant fixture 104 and implantation site 102, preventing resorption of bone at implantation site 102.

FIGS. 1A to 1E are non-limiting, exemplary overview illustrations of one or more embodiments of a fixation system of the present invention with one or more conventional intraosseous dental implant fixtures, exemplarily illustrating universal applicability of one or more embodiments of the present invention at an implantation site on a jawbone (mandible or the maxilla). In particular, FIGS. 1A to 1D are non-limiting, non-exhaustive, exemplary illustrations of various intraosseous dental implant procedures that may be practiced in accordance with one or more embodiments of the apparatus of the present invention. FIG. 1E is a close-up view of a fixation system in relation to an implant site, further detailing inner members and structure of the fixation system in accordance with one or more embodiments of the present invention.

FIG. 1F is a non-limiting exemplary exploded view illustration of the various components of fixation system in accordance with one or more embodiments of the present invention. The exploded view shown in FIG. 1F illustrates disassembled, separated components that show the cooperative working relationship, orientation, positioning, and exemplary manner of assembly of the various components of the fixation systems in accordance with one or more embodiments of the present invention, with each component detailed below.

As illustrated in FIGS. 1A to 1F, any known intraosseous dental implant procedure may be continued to be practiced using fixation system 200a illustrated in FIGS. 1A to 10 of the present invention. That is, once any one of fixation plates 100 of fixation system 200a illustrated in FIGS. 1A to 10 are associated with implantation site 102 (e.g., by using fasteners 106), and fixtures 104 are associated with fixation plates 100 in accordance with one or more embodiments of the present invention, the procedures for which are detailed below, the remaining operational procedures for intraosseous dental implant 104 may be practiced in any well-known and conventional manner.

FIG. 1A is a non-limiting exemplary illustration of an intraosseous dental implant procedure that use abutments 108 along with clinical fasteners 110 to associate a prosthetic tooth 112 with implant fixtures 104, which fixtures 104 have previously been secured to installed fixation system 200a on jawbone 102.

As another example, FIG. 1B is a non-limiting exemplary illustration of an intraosseous dental implant procedure that does not use abutments 108, instead using a healing fastener 114 that are commonly used in most intraosseous dental implant procedures.

As best illustrated in FIG. 1C, in general, healing fasteners 114 temporarily close off an axial opening 116 of fixture 104 to block and prevent food or other material from entering inside the fixture's opening 116 while allowing the gingiva or the gum to heal prior to further work.

As yet another example, FIG. 1D is a non-limiting exemplary illustration of an intraosseous dental implant procedure that uses impression coping components, comprised of fastener 118 and impression coping analog 120, for generating a mold of a prosthetic tooth 112 to be associated with fixture 104.

As illustrated in FIGS. 1A to 1D, once fixation plates 100 and fixtures 104 are associated with the desired implantation site 102 in accordance with one or more embodiments of the present invention, the remaining operational procedures for intraosseous dental implantation may be practiced in well-known and conventional manner.

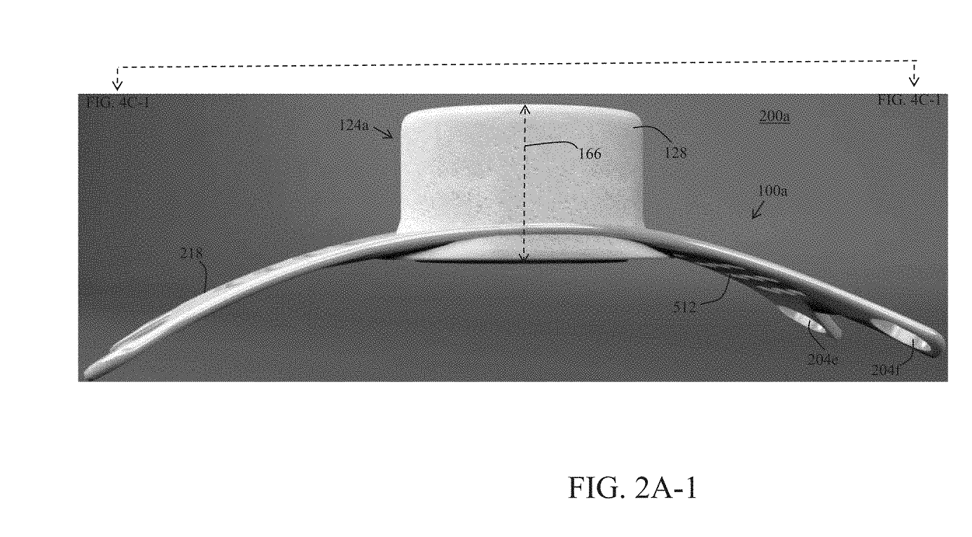

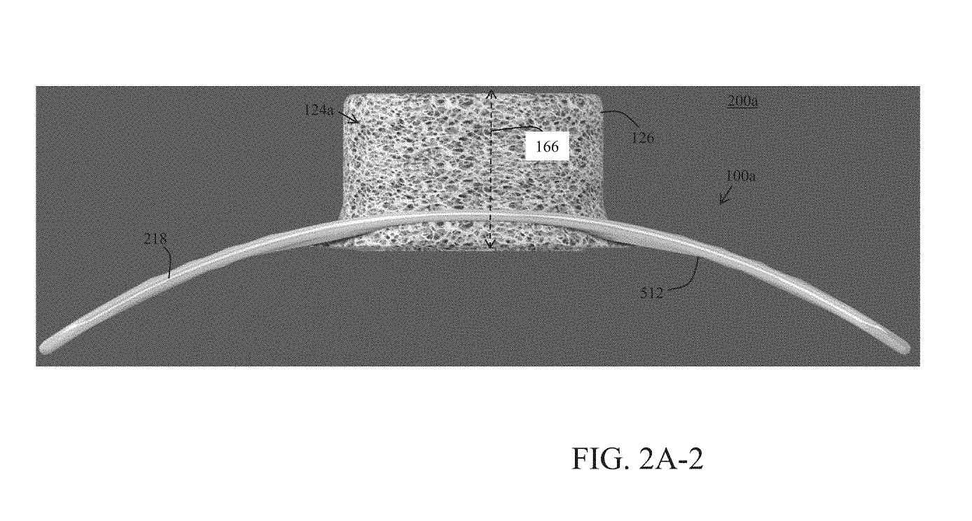

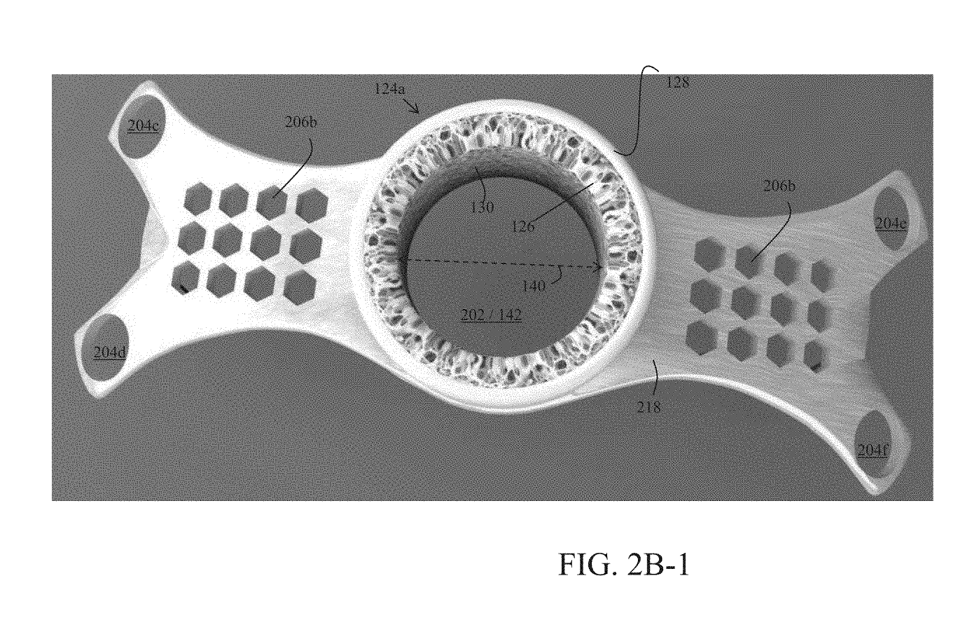

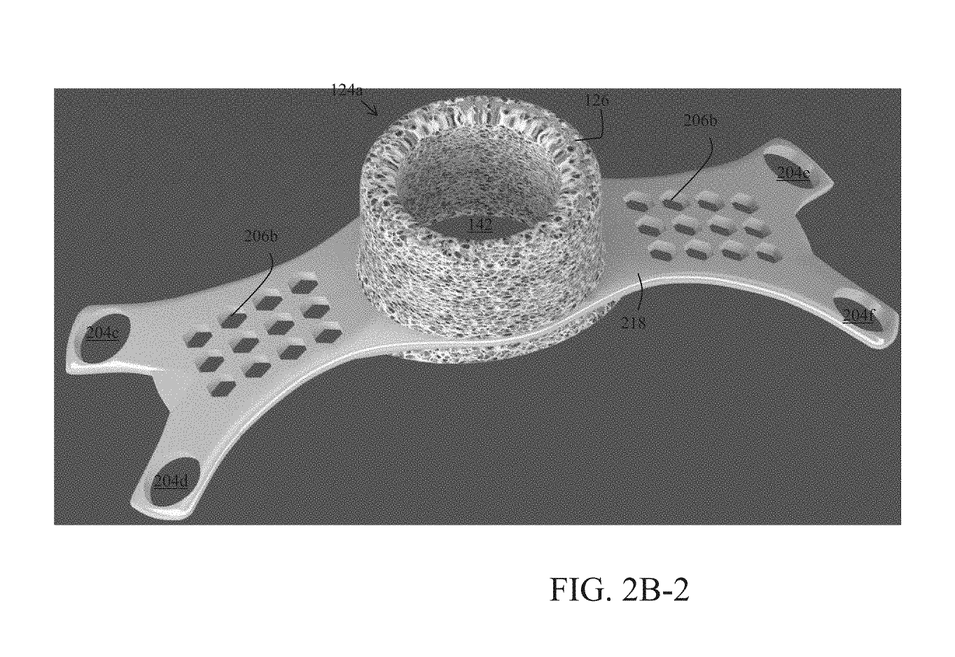

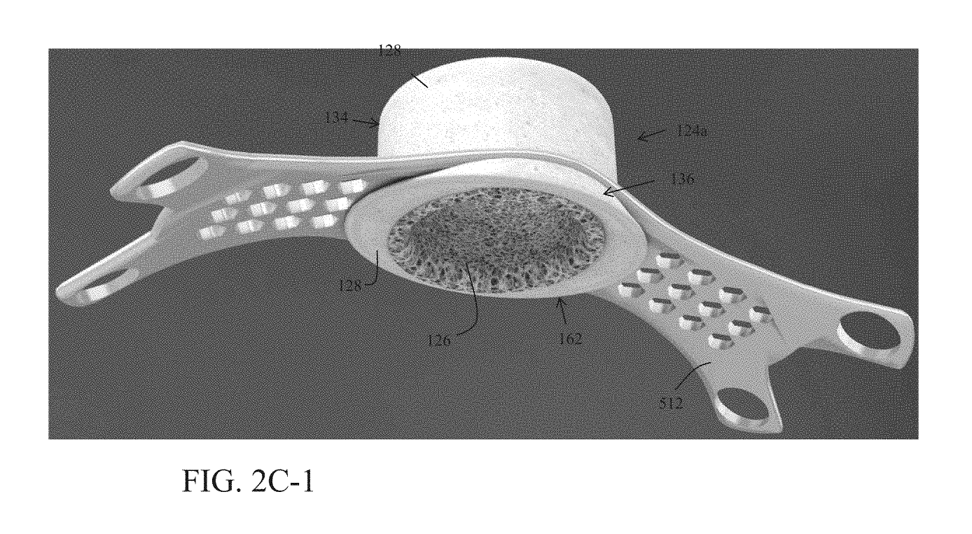

FIGS. 2A-1 to 2C-2 are non-limiting, exemplary overview illustrations of one or more embodiments of fixation systems of the present invention without showing an intraosseous dental implant fixtures in accordance with one or more embodiments of the present invention. As illustrated in FIGS. 1A to 2C-2, fixation system 200a of the present invention is comprised of fixation plate 100 and a fixation facilitator (a bone growth promoting material) 124a.

In general, all of the disclosed fixation facilitators 124 for all fixation systems 200 are comprised of well known bone growth promoting material that may be resized and are comprised of cancellous 126 and cortical 128 bone portions or, alternatively, cancellous 126 bone portion only. Fixation facilitators 124 use capillary action as a motivating force to move blood from implant site 102 and gingiva and into fixation facilitators 124 for regeneration of bone growth. Non-limiting, non-exhaustive listing of examples of fixation facilitators 124 for all fixation systems 200 are disclosed in U.S. Patent Application Publication 2007/0270812 to Peckham, the entire disclosure of which is expressly incorporated by reference herein in its entirety.

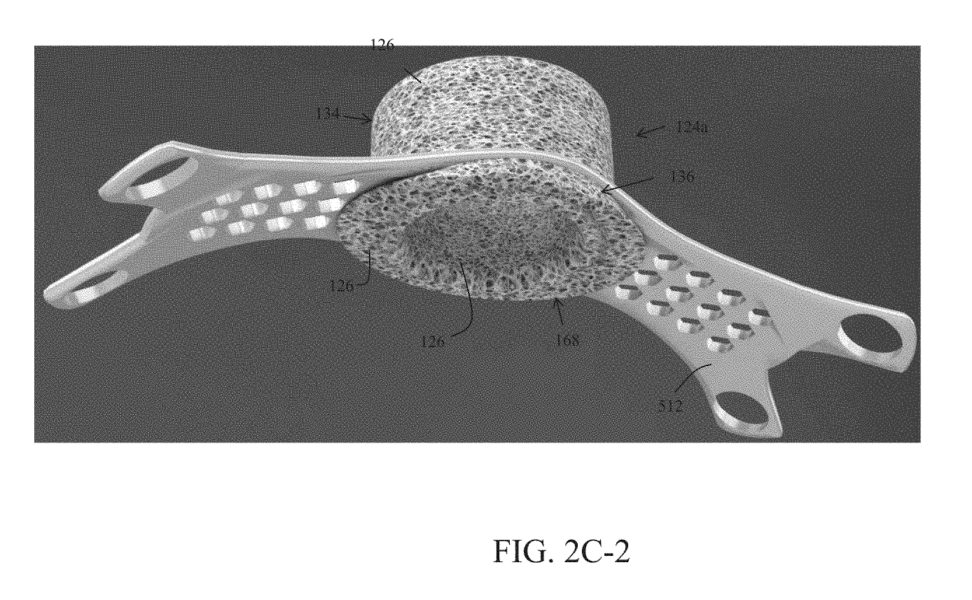

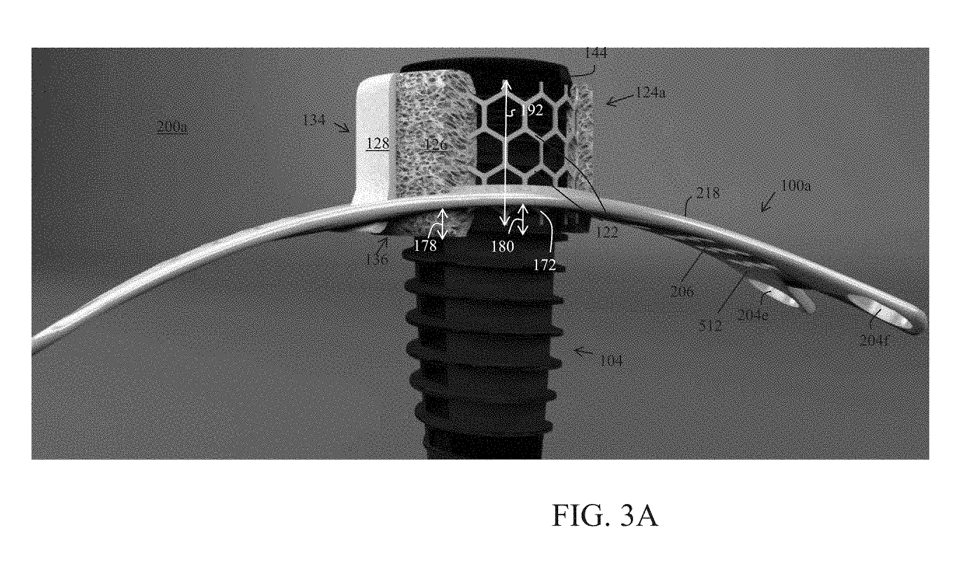

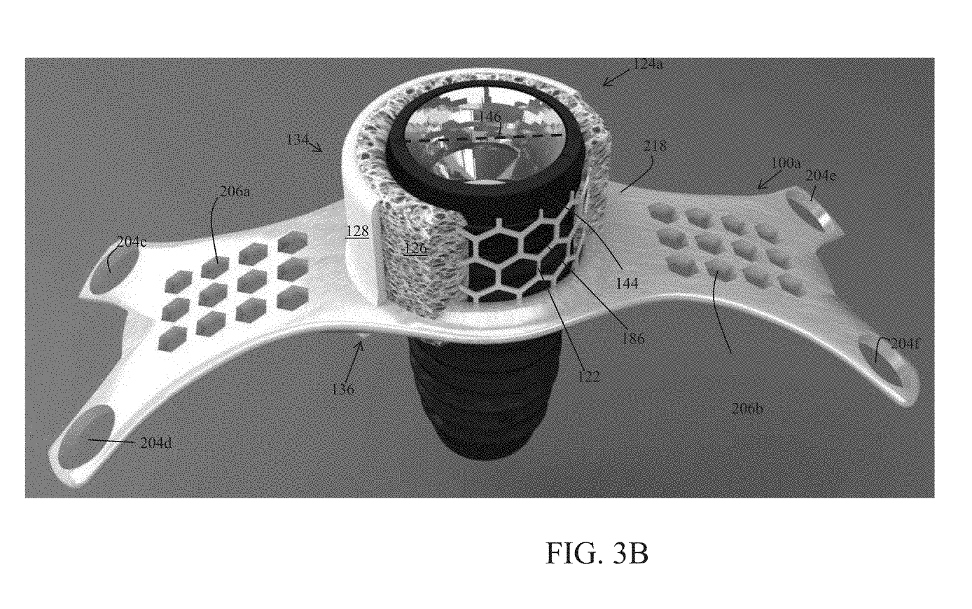

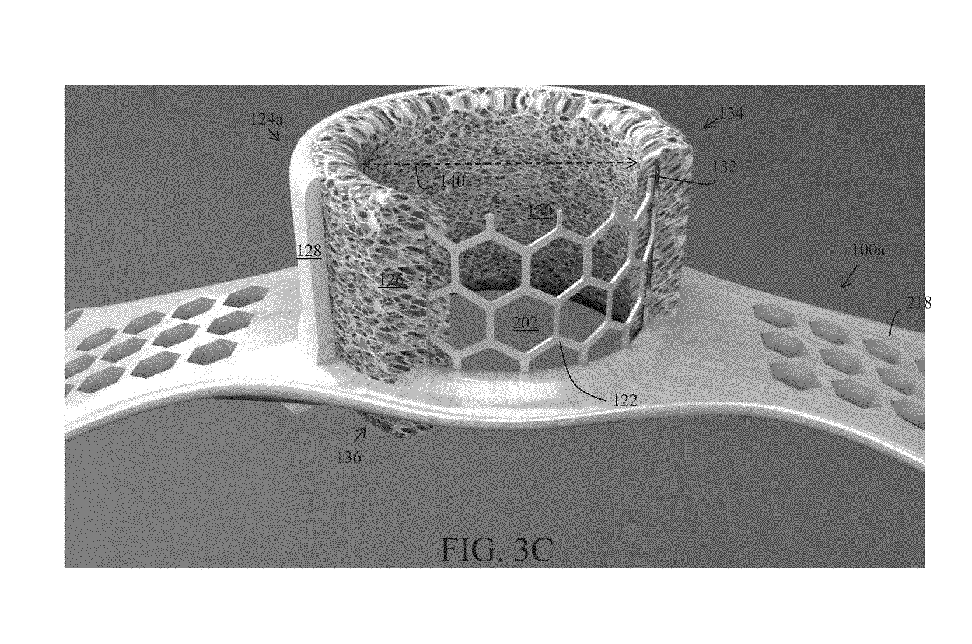

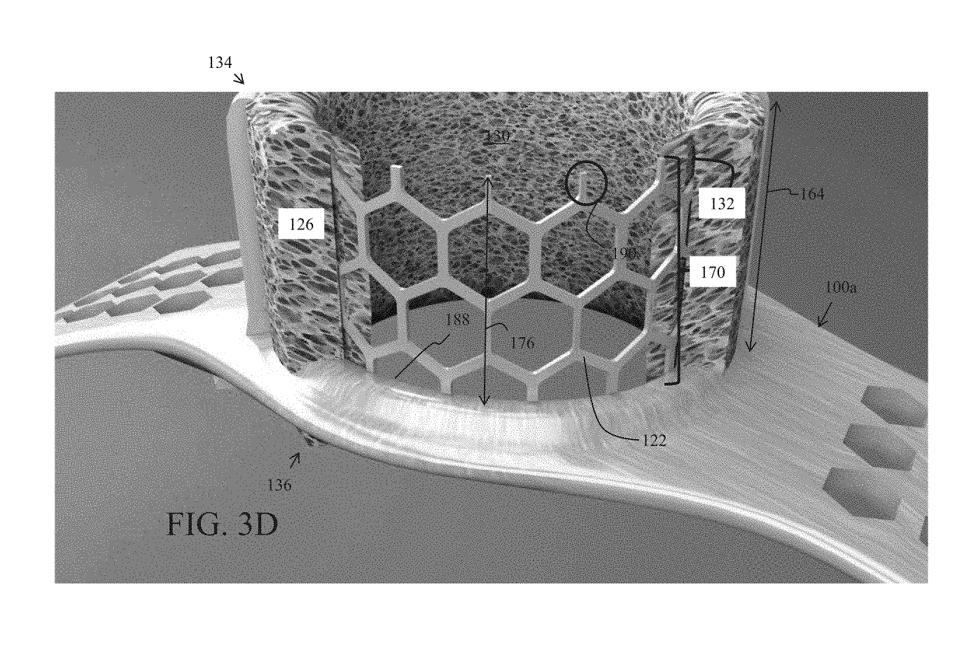

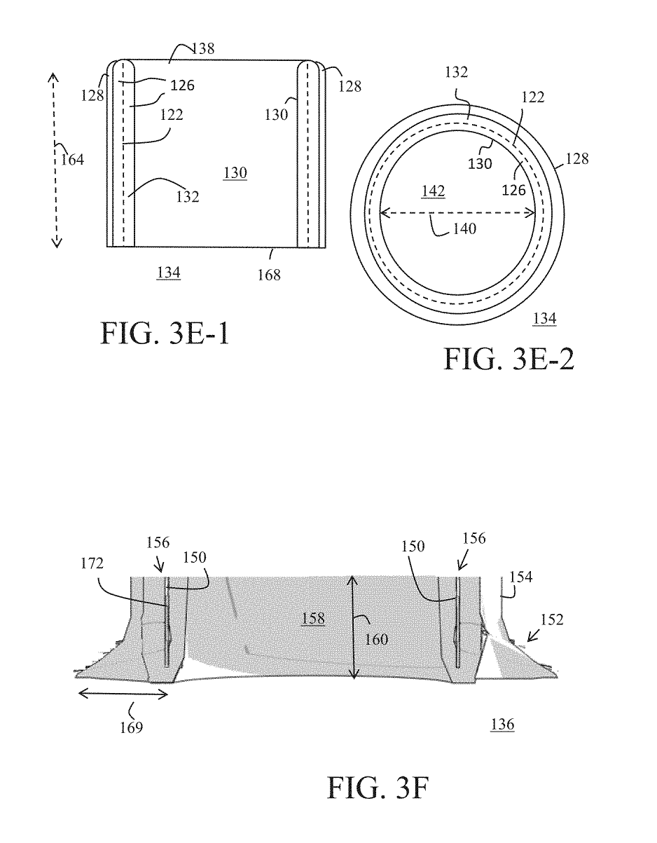

FIGS. 3A to 3F are non-limiting, exemplary overview illustrations of one or more embodiments of fixation systems of the present invention shown in FIGS. 1A to 2C-2, illustrating exposed portions of the fixation facilitator in accordance with one or more embodiments of the present invention. FIGS. 3A and 3B illustrate fixation system with intraosseous dental implant fixtures, while FIGS. 3C to 3D illustrated fixation system without intraosseous dental implant fixtures. FIG. 3E-1 is a non-limiting, exemplary schematic illustration, showing positioning of reinforcement member 122 within a sectional view of first piece of fixation facilitator, while FIG. 3E-2 illustrates the bottom view thereof. FIG. 3F is a non-limiting, exemplary schematic illustration, showing positioning of reinforcement member 122 within a sectional view of second piece 136 of fixation facilitator 124a.

As illustrated in FIGS. 1A to 3F, fixation plate 100 includes a first side 218 and a second side 512, including a hole 202 associated with fixation plate 100. Further included is a reinforcement member 122 associated with hole 202, with cancellous portion 126 of fixation facilitator 124 associated with reinforcement member 122. In the non-limiting exemplary instance illustrated, fixation facilitator 124a has a height 166 (FIG. 2A-1).

Further included is an aperture 204 for securing fixation plate 100 with a bone, and an orifice 206 for integration of fixation plate 100 with the bone. As illustrated, intraosseous dental implant fixture 104 is secured to fixation facilitator 124. That is, intraosseous dental implant fixture 104 engages with an inner wall 130 of fixation facilitator 124, providing a full, mechanical connection between both for ossiointegration.

As further illustrated, fixation facilitator 124a covers over reinforcement member 122. In other words, reinforcement member 122 is embedded within and fully covered by and encompassed within fixation facilitator 124a.

Fixation facilitator 124a is comprised of a first piece 134 and a second piece 136. First piece 134 has a generally annular cylindrical hollow body 138 with a height 164 and has a cavity 132 within body 138 for embedding upper portion 170 of reinforcement member 122.

Annular cylindrical hollow body 138 has an inner diameter 140 that defines an opening 142 for receiving intraosseous dental implant fixture 104. An outer diameter 146 (outer periphery 144) of intraosseous dental implant fixture 104 engages inner wall 130 of cancellous portion 126 of fixation facilitator 124. As illustrated in FIG. 3E-2, bottom 168 of first piece 134 is open for insertion of mesh 122 within cavity 132.

It should be noted that intraosseous dental implant fixture (threaded or not) 104 engages with inner walls 130 of bone growth promoting member 124a (reinforced by the reinforcement member 122). This type of engagement between both provides a full, mechanical connection for appropriate ossiointegration. This type of engagement is similar to existing intraosseous dental implant fixtures 104 that are fastened into jawbone 184. In other words, upper portion threading 186 accompanying intraosseous dental implant fixture 104 that would have engaged jawbone 184 (which obviously has no threading) would now be engaging fixation facilitator 124a reinforced by reinforcement member 122.

As indicated above, fixation facilitator 124a is comprised of first piece 134 that is mounted onto a first (or upper) portion 170 of reinforcement member 122 extending from first side 218 of fixation plate 100, and second piece 136 that is mounted onto a second (or lower) portion 172 (FIG. 3A) of reinforcement member 122 extending from second side 512 of fixation plate 100. First piece 134 has height 164 that has a longer span than a height 178 of second piece 136 to accommodate a longer height 176 first portion 170 of reinforcement member 122, compared with a shorter height 180 of second portion 172 of reinforcement member 122. It should be noted that height 180 of second portion 172 of reinforcement member 122 is constant whereas height 178 of second piece 136 varies generally commensurately with curvature of all of the disclosed fixation plates 100 of fixation system 200a.

As more clearly visible in FIG. 1F, second piece 136 of fixation facilitator 124a is comprised of annular structure 148 with a cavity 150 that receives a second portion 172 of reinforcement member 122. Annular structure 148 has a radial slopping beveled outer sides 152 at a lower portion, providing a wider bottom surface area (larger bottom “footprint” 169), and a generally linear upper portion 154 that includes opening 156 of cavity 150 (similar to the way the bottom end of cavity 132 is open for first piece 134). Interior side 158 of annular structure 148 is generally linear, defining the overall height 160 thereof.

Second piece 136 of fixation facilitator 124a is in direct, mechanical contact with implant site 102, and first piece 134 of fixation facilitator 124a is encased with the gingiva. Both first and second portions 134 and 136 of fixation facilitator 124a facilitate the required capillary action as a motivating force to move blood from gingiva and implant site 102 and into fixation facilitator 124a for regeneration of bone growth.

In general, implantation site 102 may include one of a countersink or counterbore (best shown in FIG. 1E) 182 for receiving and housing second piece 136. Countersink or counterbore 182 must have a sufficient depth to secure fixation plate 100 (and hence, second piece 136 of fixation facilitator 124a) with the depth past the cortical of jawbone 184, reaching the cancellous portion of jawbone 184 that includes rich blood flow. The blood flow from cancellous portion of jawbone 184 of implant site 102 would flow via capillary action of cancellous portion of fixation facilitator 124a and into bone growth promoting member 124a. In other words, fixation facilitator 124a wicks blood from all sides (implant site 102, gingiva, etc., via capillary action). Once fixation system 200a is implanted and the existing intraosseous dental implant fixture 104 is fixed onto fixation system 200a, closeting fixation system 200a with gingiva will enable first piece 134 of fixation facilitator 124a to also wick blood via capillary action from gingiva, which facilitates ossiointegration all around implant site 102.

As with reinforcement member 122 (detailed below), total height 166 of fixation facilitator 124a (both first portion 134 or second portion 136) may be adjusted commensurate with need and requirements of implantation sites 102. In other words, a simple cutting tool such as scissors may be used to shorten height 166 of fixation facilitator 124a, including cutting height of embedded reinforcement member 122. For smaller adjustments, any well-known shaving tools may be used to shave-off a smaller portion of height at either end (first portion 134 and or second portion 136).

The ability to adjust the height of reinforcement member 122 and fixation facilitator 124a enables the use of fixation system 200a at any desired implant site that is qualified for application and use of existing intraosseous dental implant fixture 104 with different heights. This also results in an even elevation of the final implant with the remaining bone structure regardless of the underlying topography of implant site 102.

Reinforced fixation facilitator 124a (reinforced by reinforcement member 122) provides universality with respect to use of different types, models, and makes of conventional intraosseous dental implant fixture (including those that are not threaded) 104 and universality with respect to the application of fixation system 200a at desired implant site 102. In other words, universality is accomplished in terms of application of fixation system 200a to desired implant site 102 and in terms of usage of desired different types, makes, and models of existing intraosseous dental implant fixture 104 due to resiliency of fixation facilitator 124a and its adjustability. That is, due to its resiliency, fixation facilitator 124a may receive intraosseous dental implant fixture 104 with a variety of different diameters (threaded or not), which is further supported by reinforcement member 122. Further, due to its adjustable height, different lengths of intraosseous dental implant fixtures 104 may be used. Accordingly, universality is accomplished due to the use of different types, makes, and models of existing intraosseous dental implant fixtures 104 (with varying diameters, lengths, etc.). For example, the jawbone's posterior part generally requires larger diameter intraosseous dental implant fixtures 104, whereas the anterior part thereof requires smaller diameter fixtures that may be longer or shorter in height.

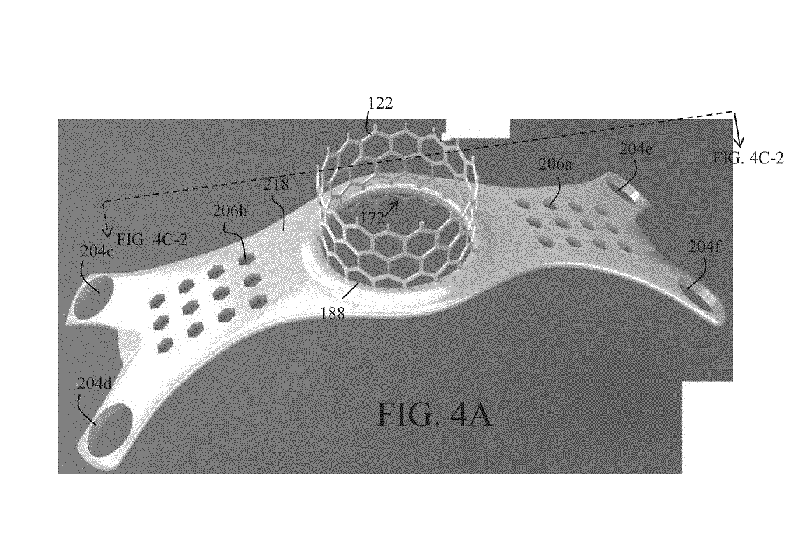

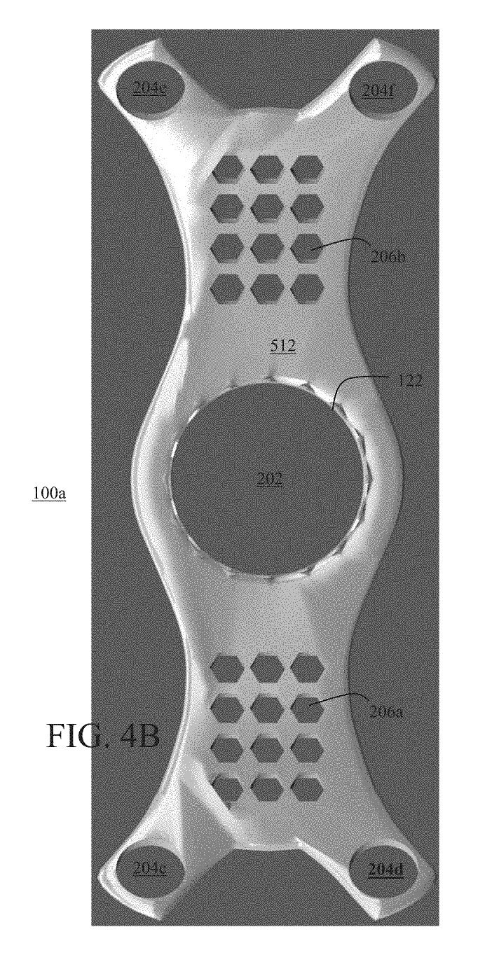

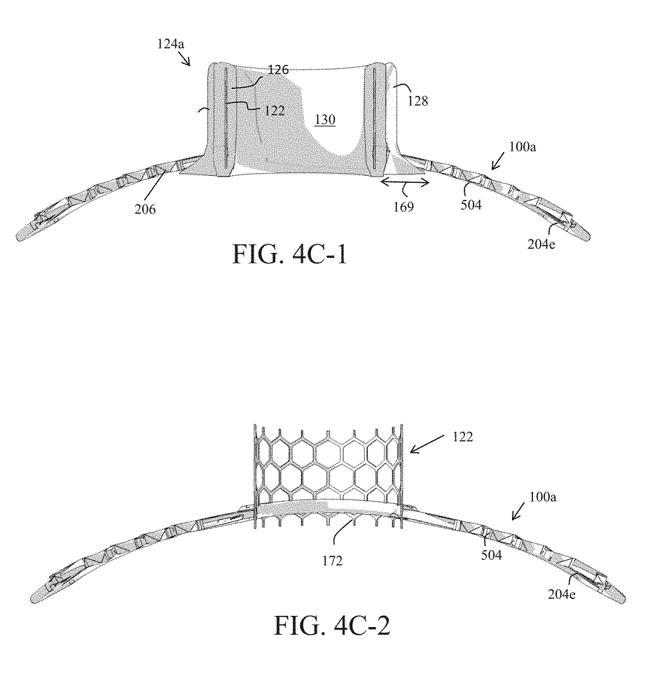

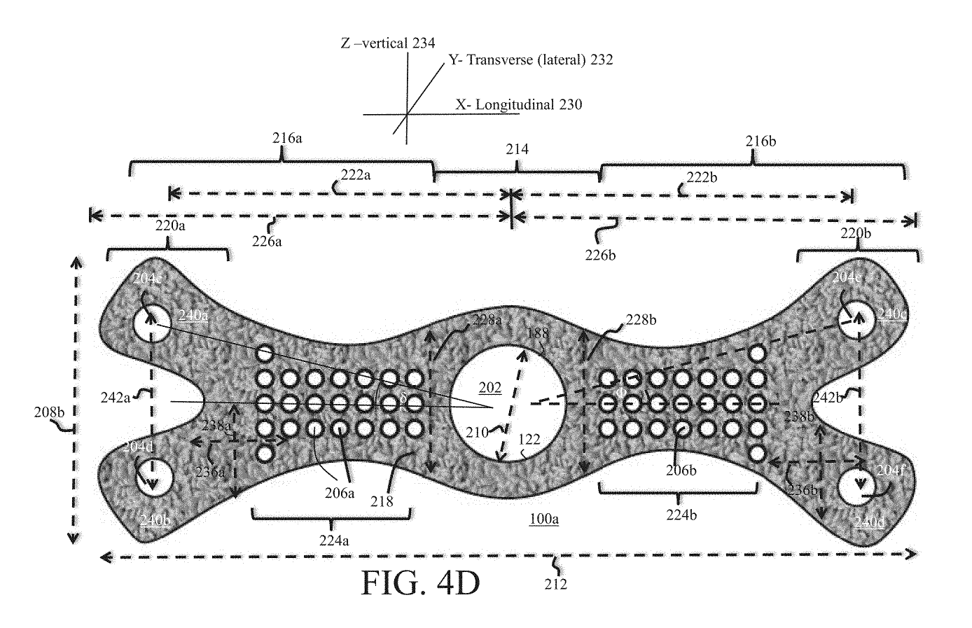

FIGS. 4A to 4D are a non-limiting, exemplary illustrations of an embodiment of a fixation plate without the fixation facilitator and without the intraosseous dental implant fixture in accordance with the present invention. As illustrated, the present invention provides an apparatus in a form of a non-limiting, exemplary preferred embodiment of a fixation plate that has an upper (top or first) side 218 and lower (bottom or second) side 512.

As best illustrated in FIGS. 4A to 4D, fixation plate 100a includes one or more holes (or fixture hole 202) for receiving intraosseous dental implant fixture 104. In other words, cortical thread part 186 of intraosseous dental implant fixture 104 is coupled with fixation facilitator 124a of fixation plate 100a. Reinforcement member 122 is mechanically connected (e.g., welded) with a perimeter 188 of hole 202, and fully embedded within fixation facilitator 124a as best illustrated in FIGS. 3C and 3D.

Fixation plate 100a further includes one or more aperture 204 for securing the fixation plate 100a with jawbone 184 (the mandible or the maxilla), and one or more orifice 206 for integration of fixation plate 100a with the bone (e.g., osseointegration with the implantation site 102 on the mandible or the maxilla). The number, arrangement, and shapes of orifices 206 may vary even within a curved connection section 216 (FIG. 4D) of the same fixation plate 100a. In general, all openings and edges of all of the fixation plates 100 of fixation system 200a are curvy with no sharp edges.

As further illustrated in FIGS. 4A to 4D (best shown in FIG. 4D), fixation plate 100a of the present invention is a single, integral piece comprised of a central region 214 that accommodates hole (fixture hole) 202 from which laterally extend first and second curved connection sections 216a and 216b of fixation plate 100a. As best illustrated in FIG. 1A to 1D, curved connection sections 216a and 216b of fixation plate 100a are adapted to be coupled with buccal and lingual sections of bone 184.

Curved connection sections 216a and 216b are comprised of ossiointegration sections 224a and 224b (detailed below) and distal sections 220a and 220b. Therefore, curved connection sections 216a and 216b have corresponding apertures 204a and 204b in the distal sections 220a and 220b to receive and securely maintain fasteners 106, e.g. small titanium self-tapping screws (FIGS. 1A to 1D) to connect fixation plate 100a to bone 184; and each curved connection section 216a and 216b has at least one or more orifices 206a and 206b to allow more efficient and effective osseointegration.

Additionally, as indicated above, one or more fastener apertures 204 are at approximate distal sections 220a and 220b of curved connection sections 216a and 216b of fixation plate 100a, away from fixture hole 202. Distal sections 220a and 220b provide wider body expanse or area around fastener apertures 204a and 204b for increased anchoring base for added structural integrity for anchoring and support.

In one or more embodiments, fixture hole 202 has a first distance 222a from the one or more fastener apertures 204c/d, and a second distance 222b from the other one of one or more fastener apertures 204e/f, with the first and second distances 222a and 222b preferably being equal. The one or more integration orifices 206a and 206b are positioned between fixture hole 202 and the one or more fastener apertures 204c/d and 204e/f, forming the sections 224a and 224b.

Fixation plate 100a has a plate longitudinal axis 230 and a plate transverse axis 232, with a plate axial length 212 parallel that of plate longitudinal axis 230 and a plate transverse width 208 parallel that of plate transverse axis 232. Axial length 212 of fixation plate 100a is longer than transverse width 208 to enable curved connection sections 216a and 216b to connect with the buccal and lingual sections of implantation site 102.

Lateral extending curved connection sections 216a and 216b of fixation plate 100a also include a sectional longitudinal axis 236a and 236b and a sectional transverse axis 238a and 238b. Sectional axial lengths 226a and 226b of connection sections 216a and 216b are parallel sectional longitudinal axis 236a and 236b of curved connection section 216a and 216b, and sectional transverse widths 228a and 228b of curved connection section 216a and 216b are parallel sectional transverse axis 238a and 238b of curved connection section 216a and 216b.

Sectional transverse widths 228a and 228b of curved connection sections 216a and 216b vary (along sectional longitudinal axis 236a and 236b) from a proximal section of curved connection section 216a and 216b near hole 202 (near central region 214) to respective distal sections 220a and 220b, forming a curved silhouette of laterally extending curved connection sections 216a and 216b as illustrated. This provides more material near central region 214 and distal sections 220a and 220b for added strength and improved structural integrity for accommodating fixture 104 and fasteners 106. At the same time, the narrower sections (generally indicated at 224) reduce the amount of material and reduce cost of manufacturing fixation plates 100.

As further illustrated in FIGS. 4A to 4D, in this non-limiting, exemplary preferred embodiment, fixation plate 100a is provided with bifurcated distal sections 220a and 220b. The reason for the use of bifurcated branching of apertures 204 along distal sections 220a and 220b of curved connection sections 216a and 216b is if bone loss exists, the inserted ends of fasteners 106 will not come into contact with the lower portion of intraosseous dental implant fixture 104.

Bifurcated branches 240 of distal sections 220a and 220b guide fastener 106 insertions away from intraosseous dental implant fixture 104 rather than directly towards it. This is partly due to bifurcated branches 240 having an angle 1 in relation to the center of first hole 202. Further, bifurcated branches 240 add separation distance 242 between apertures 204 to provide a wider span, base, or foundation for improved stability and anchoring of fixation plate 100a.

As further illustrated in FIGS. 4A to 4D, it should be noted that each bifurcated branch 240a, 240b, 240c, and or 240d may have different positional, angular, distal, and orientational relation to one another and or in relation to fixture hole 202. For example, bifurcated branch 240a with its aperture 204c may be positioned at a further distance from and at a different angle of δ to fixture hole 202 compared with the rest of branches 240b, 240c, and or 240d. As another example, the angular and distal positions of bifurcated branches 240a and 240d may be identical in relation to fixture hole 202, but different from bifurcated branches 240c and 240b. Accordingly, various combinations and permutations of different positional, angular, distal, and orientational relation of each bifurcated branch 240a, 240b, 240c, and 240d with respect to each other and or the first hole 202 are possible. FIG. 4A is a non-limiting, exemplary illustration of a first side of apparatus 100a with fasteners 106 associated with apertures 204, and FIG. 4B illustrates the same but showing the second (or bottom) side. As illustrated in FIG. 4B, second side 512 of plate 100 (all plates) is curved and has a textured surface for improved ossiointegration. FIGS. 4C-1 and 4C-2 are non-limiting, exemplary sectional profile illustrations showing fixation plate 100 having a general thickness 504.

Fixture hole 202 includes reinforcement member 122 that may be configured as a hexagonal mesh selected from a variety of materials including titanium, titanium alloys, or other medically appropriate metallic or rigid members. A total height 192 of reinforcement member 122 (which also extends from a second side 512 of fixation plate 100a) may be adjusted by a physician depending on the requirements of implant site 102.

As detailed below, reinforcement member 122 functions as a “rebar” that provides support for bone growth promoting member 124a and reduces parafunctional stresses that may result in resorption of the bone growth promoting member 124a in addition to bone of the implant site. In other words, reinforcement member 122 absorbs and distributes parafunctional forces to fixation plate 100a, which in turn, distributes those forces to a wider underlying topography of implant site 102.

As best illustrated in FIG. 3D, reinforcement member (or the mesh) 122 has a hexagonally patterned (or “honey comb”) structure, with protruding first and second sets of engagement posts 190 that extend from first and second distal ends of reinforcement member 122, passing through respective cavities 132 and 150 of first and second pieces 134 and 136 of bone growth promoting member 124a and penetrating into cancellous portion 128 of bone growth promoting member 124a.

Upper side 218 of fixation plate 100a may include recessed portions (e.g., countersinks and or counter-bores) formed from beveled edges on upper side 218 surrounding the interior surface of one or more fastener apertures 204 to enable coupling of fasteners 106 (e.g., screw's head) flush with upper side 218. The recessed fastener aperture 204 on the surfaces of connection sections 216 allow them to be secured to jawbone 184 by small titanium fasteners 106 so that connection sections 216 and fastener heads are flush.

Optionally, curved connection sections 216 may also be provided with “punched” grooves to ensure proper bending and correct sealing with jawbone 184. Further, the general fixation plate sizes are projected in a way to have standard relation with neighboring teeth or implants.

In general, surface of fixation plates 100 (including reinforcement member 122) and fasteners 106 are modified to enhance and facilitate direct structural and functional connection between the bone and the plate/screws. That is, fixation plate 100 and fastener 106 are processed through well known methods, also used commonly for conventional intraosseous dental implant fixture 104, to significantly improve osseointegration, non-limiting examples of such well known methods may include sandblasting, etching, hydroxylapatite coating, etc. Non-limiting examples of material of the plate/fasteners may include Titanium, Aluminum, Vanadium or combinations of alloys thereof such as Ti-6Al-4V. In other words, the material and processing methods of the plates/screws are similar to those used to manufacture and process existing root-shape intraosseous dental implants, which techniques improve osseointegration.

As specific non-limiting examples, in order to improve Bone-Plate Contact (BPC), the surfaces of plate 100 may be treated with well known and conventional sandblasting and acid-etching techniques. To obtain the best possible results in osseointegration, particles of TiO₂, or hydroxylapatite (HA) with non-limiting, exemplary sizes of about 25 μm to about 50 μm in diameter may be used as sandblasting material. After sandblasting, acid-etching with either oxalic, hydrochloric HCl, sulfuric acid H₂SO₄, or other suitable material may be used to smooth the irregular, full of sharp tips rough surfaces (caused by sandblasting) and to remove any embedded sandblast particles. The embedded particles and possible polluting matters, e.g. sandblast particles, are also thoroughly removed by acid etching, resulting in drastic reduction in the Ti corrosive rate. Acid-etching modification further creates numerous secondary micropores (with a non-limiting, exemplary preferred embodiment of about 2.0 μm diameter) on the basis of sandblasted surface macrotexture. The well-known methodologies of sandblasting and surface treatment using acid etching are feasible, reliable, and do not decrease the biocompatibility of titanium. Thus, owing to surface roughness and numerous micropores and embedded HA particles, the surface area of plate 100 is increased up to 90% or more, which contributes highly to efficient osseointegration and reduces required osseointegration time. It should be noted that other methods of HA coating, such as the use of nano-sized particles is possible.

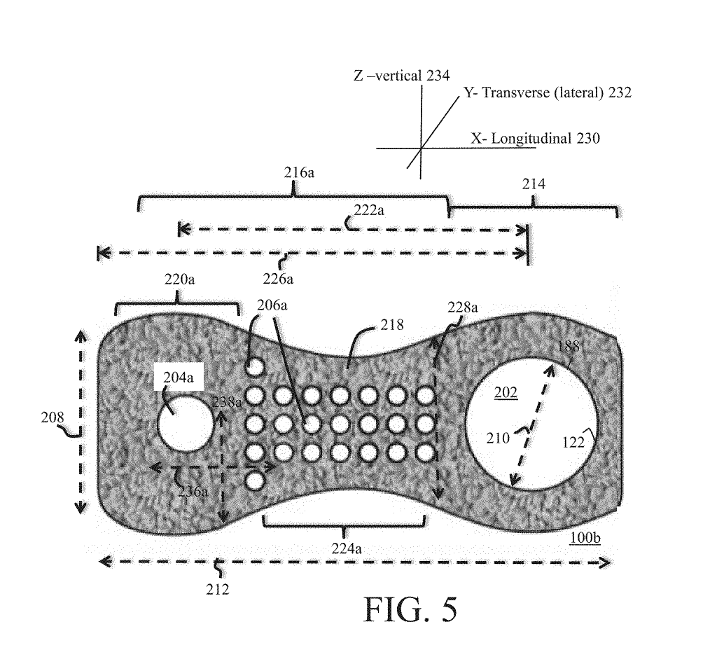

FIG. 5 is non-limiting, exemplary illustrations of a fixation system 200a with a fixation plate 100b that has non-bifurcated single connection section in accordance with another embodiment of the present invention. The fixation plate 100b illustrated in FIG. 5 includes similar corresponding or equivalent components, interconnections, functional, operational, and or cooperative relationships as fixation plate 100a that is shown in FIGS. 1A to 4D, and described above. Therefore, for the sake of brevity, clarity, convenience, and to avoid duplication, the general description of FIG. 5 will not repeat every corresponding or equivalent component, interconnections, functional, operational, and or cooperative relationships that has already been described above in relation to fixation plate 100a that is shown in FIGS. 1A to 4D.

As illustrated, in this non-limiting, exemplary instance, fixation plate 100b includes only a single connection section 216a. Further, distal end 220a is not bifurcated, making the device simpler to manufacture and use.

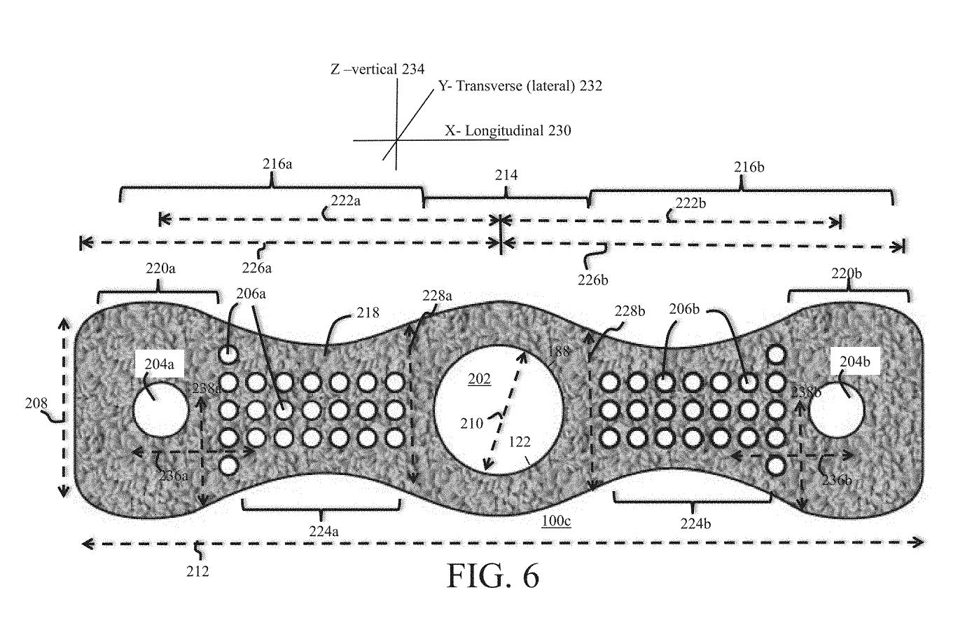

FIG. 6 is non-limiting, exemplary illustrations of a fixation system 200a with a fixation plate 100b that has non-bifurcated single connection section in accordance with another embodiment of the present invention. The fixation plate 100c illustrated in FIG. 6 includes similar corresponding or equivalent components, interconnections, functional, operational, and or cooperative relationships as fixation plate 100a and 100b that are shown in FIGS. 1A to 5, and described above. Therefore, for the sake of brevity, clarity, convenience, and to avoid duplication, the general description of FIG. 6 will not repeat every corresponding or equivalent component, interconnections, functional, operational, and or cooperative relationships that has already been described above in relation to fixation plates 100a and 100b that are shown in FIGS. 1A to 5.

As illustrated, in this non-limiting, exemplary instance, distal ends 220a and 220b are not bifurcated, making the device simpler to manufacture and use. It should be noted that in this non-limiting, exemplary instance, at least one sectional longitudinal axis 236a and 236b of at least one laterally extending curved connection section 216a and 216b may be parallel to that of plate longitudinal axis 230 (and hence, the plate axial length 212). Further, in this non-limiting, exemplary instance, at least one sectional transverse axis 238a and 238b of at least one laterally extending curved connection section 216a and 216b may be parallel to that of plate transverse axis 232 (and hence, the plate transverse width 208).

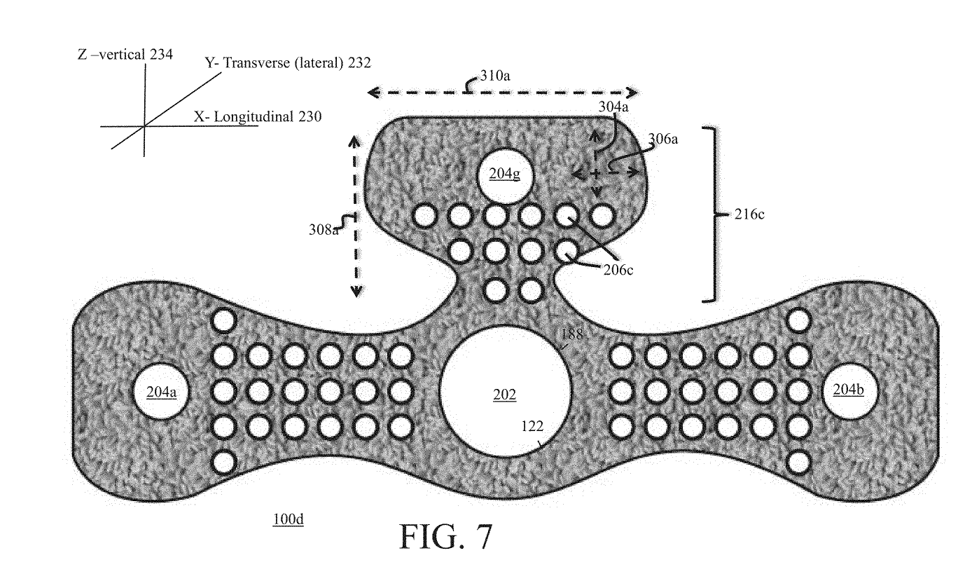

FIG. 7 provides non-limiting, exemplary illustrations of an embodiment of an apparatus in accordance with the present invention. Fixation plate 100d illustrated in FIG. 7 includes similar corresponding or equivalent components, interconnections, functional, and or cooperative relationships as fixation plates 100a, 100b, and 100c that are shown in FIGS. 1A to 6, and described above. Therefore, for the sake of brevity, clarity, convenience, and to avoid duplication, the general description of FIG. 7 will not repeat every corresponding or equivalent component, interconnections, functional, and or cooperative relationships that has already been described above in relation to fixation plates 100a, 100b, 100c that are shown in FIGS. 1A to 6.

FIG. 7 illustrates a non-limiting, exemplary preferred embodiment of the invention with a fixation plate 100c comprised of a central region 214 that accommodates fixture hole 202 from which radially extend connection sections 216, forming a triple connection fixation plate 100c. Fixation plate 100c includes an additional connection section 216c, which itself may be secured on a crest of the jawbone 184. In this embodiment, at least one sectional longitudinal axis 236 of at least one radially extending connection section 216 parallel that of plate longitudinal axis 230 and at least one sectional longitudinal axis 304a of at least one radially extending connection section 216c parallel that of plate transverse axis 232. Third connection section 216c is shorter in length 308a and may be wider in width 310a compared with length 226 and width 228 of the wing sections 216 and is for connection with the crestal bone area of jawbone 184. Further, positional, angular, distal, and orientation of aperture 204g with respect to the reset of fixation plate 100c body, including apertures 204a and 204b and or fixture hole 202 may be varied.

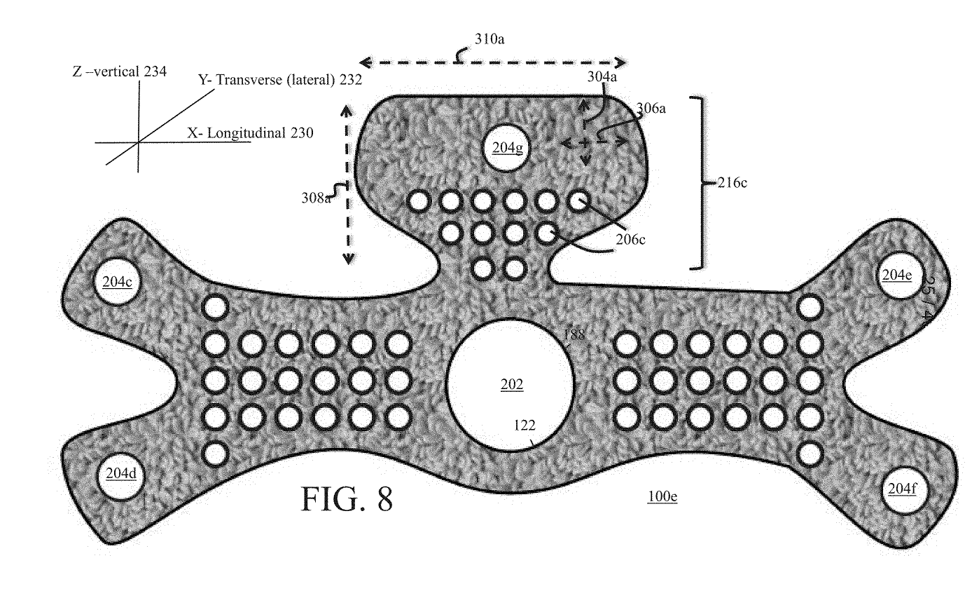

FIG. 8 is non-limiting, exemplary illustrations of an embodiment of an apparatus in accordance with the present invention. Fixation plate 100e illustrated in FIG. 8 includes similar corresponding or equivalent components, interconnections, functional, and or cooperative relationships as fixation plates 100a, 100b, 100c, 100d that are shown in FIGS. 1A to 7, and described above. Therefore, for the sake of brevity, clarity, convenience, and to avoid duplication, the general description of FIG. 8 will not repeat every corresponding or equivalent component, interconnections, functional, and or cooperative relationships that has already been described above in relation to fixation plates 100a, 100b, 100c, 100d that are shown in FIGS. 1A to 7. As illustrated in FIG. 8, the present invention provides an apparatus in a form of a non-limiting, exemplary preferred embodiment of a plate 100e (which is a combination of fixation plates 100a and 100d). In this embodiment, in addition to the third connection section 216c as in fixation plate 100c, distal sections 220a and 220b of fixation plates 100d are bifurcated.

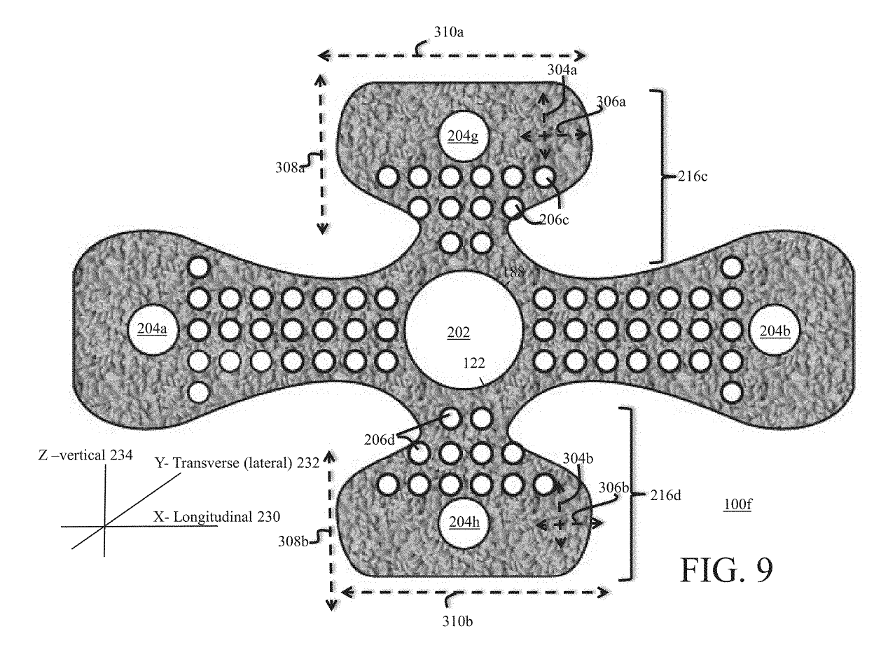

FIG. 9 is non-limiting, exemplary illustrations of an embodiment of an apparatus in accordance with the present invention. Fixation plate 100f illustrated in FIG. 9 includes similar corresponding or equivalent components, interconnections, functional, and or cooperative relationships as the fixation plates 100a, 100b, 100c, 100d, 100e that are shown in FIGS. 1A to 8, and described above. Therefore, for the sake of brevity, clarity, convenience, and to avoid duplication, the general description of FIG. 9 will not repeat every corresponding or equivalent component, interconnections, functional, and or cooperative relationships that has already been described above in relation to fixation plates 100a, 100b, 100c, 100d, 100e that are shown in FIGS. 1A to 8. As illustrated in FIG. 9, the present invention provides an apparatus in a form of a non-limiting, exemplary preferred embodiment of a fixation plate 100f (which is a combination of fixation plates 100c and 100d), but with an additional connection section 216d. The positional, angular, distal, and orientation of second hole 204h with respect to the reset of fixation plate 100f, including apertures 204a, 204b, 204g, and or fixture hole 202 may be varied. As with section 216c, connection section 216d may also be used for connection with the crestal bone area of jawbone 184.

FIG. 10 is non-limiting, exemplary illustrations of an embodiment of an apparatus in accordance with the present invention. Fixation plate 100g illustrated in FIG. 10 includes similar corresponding or equivalent components, interconnections, functional, and or cooperative relationships as fixation plates 100a, 100b, 100c, 100d, 100e, 100f that are shown in FIGS. 1A to 9, and described above. Therefore, for the sake of brevity, clarity, convenience, and to avoid duplication, the general description of FIG. 10 will not repeat every corresponding or equivalent component, interconnections, functional, and or cooperative relationships that has already been described above in relation to fixation plates 100a, 100b, 100c, 100d, 100e, 100f that are shown in FIGS. 1A to 9. As illustrated in FIG. 9, the present invention provides an apparatus in a form of a non-limiting, exemplary preferred embodiment of a fixation plate 100g (similar to that of fixation plate 100f in FIG. 9), but with bifurcated distal sections along connection sections 216a and 216b. The number of connection sections 216 should not be limited to the four shown and can be increased, but four is preferred due to the small size of the component.

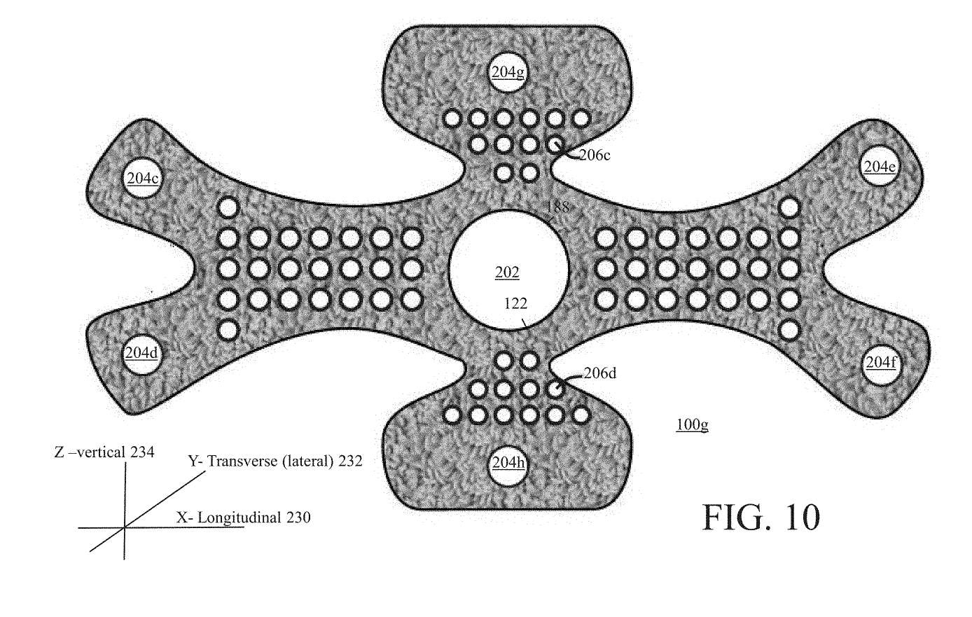

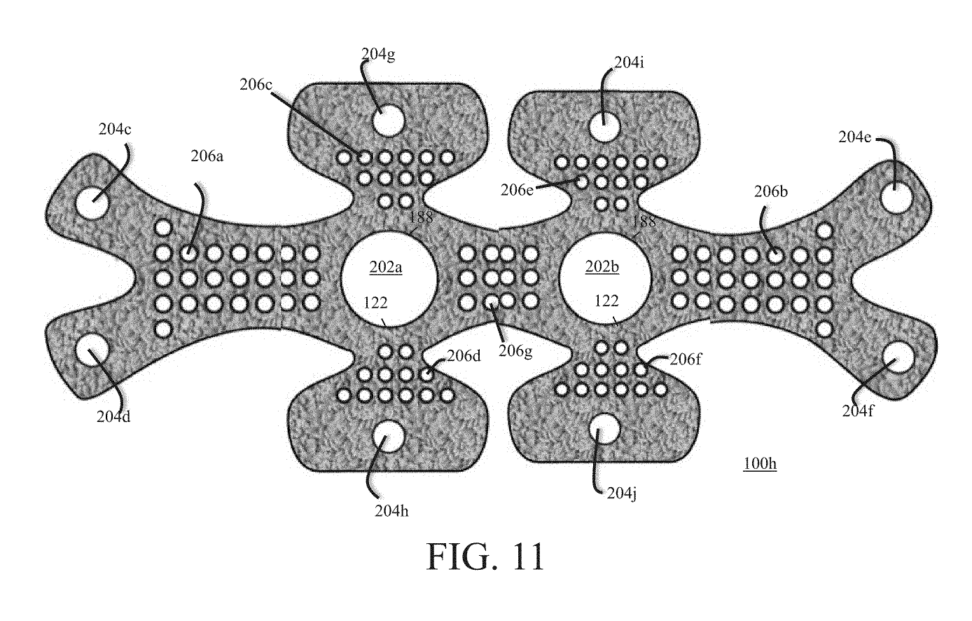

FIG. 11 is non-limiting, exemplary illustration of an embodiment of an apparatus in accordance with the present invention. Fixation plate 100h illustrated in FIG. 11 includes similar corresponding or equivalent components, interconnections, functional, and or cooperative relationships as fixation plates 100a, 100b, 100c, 100d, 100e, 100f, 100g that are shown in FIGS. 1A to 10, and described above. Therefore, for the sake of brevity, clarity, convenience, and to avoid duplication, the general description of FIG. 11 will not repeat every corresponding or equivalent component, interconnections, functional, and or cooperative relationships that has already been described above in relation to fixation plates 100a, 100b, 100c, 100d, 100e, 100f, 100g that are shown in FIGS. 1A to 10. As illustrated in FIG. 11, the present invention provides an apparatus in a form of a non-limiting, exemplary preferred embodiment of a fixation plate 100h that includes two fixture holes 202a and 202b, including additional connection sections 216.

Accordingly, the present invention provides non-limiting, exemplary preferred embodiments, such as double, triple, and quadruple formations (with or without bifurcated Y-shape or split ends or branches), with the use of each depending on a number of implants, installation position and the type of fixture (the dental implant portion within the bone or the shaft or the shank part of the dental implant) used. It should be noted that the illustrated bifurcated distal ends of the connection sections need not be equal in dimension to one another, and may be varied. Further, fixture hole 202 may or may not be equally distanced from any of one or more fastener apertures 204.

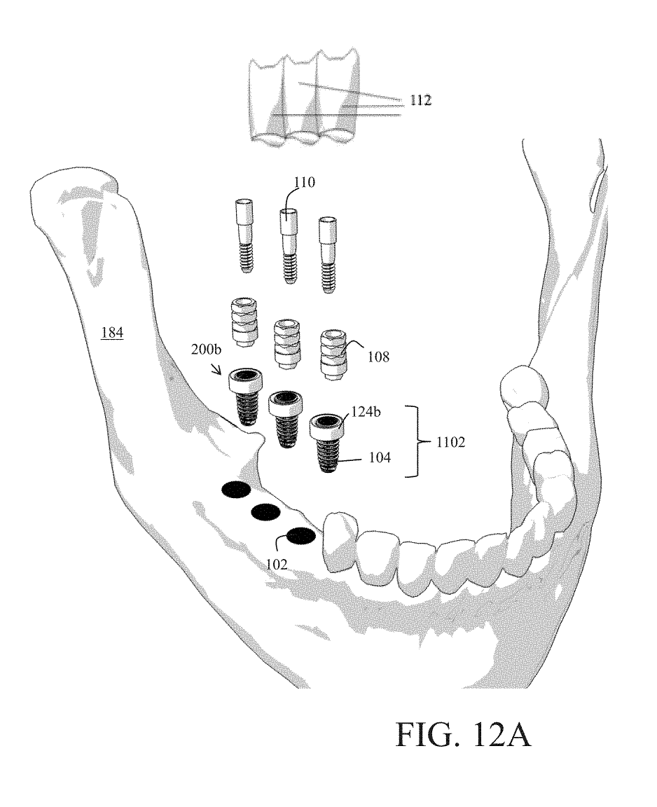

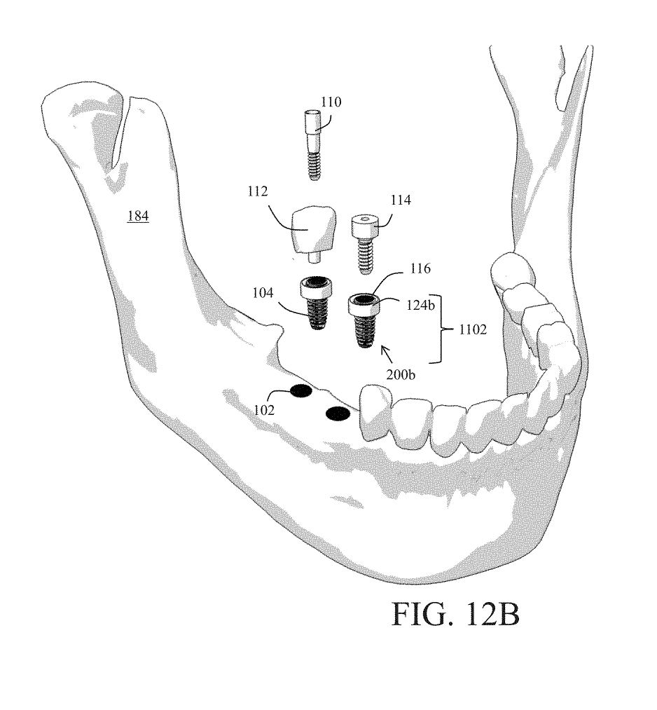

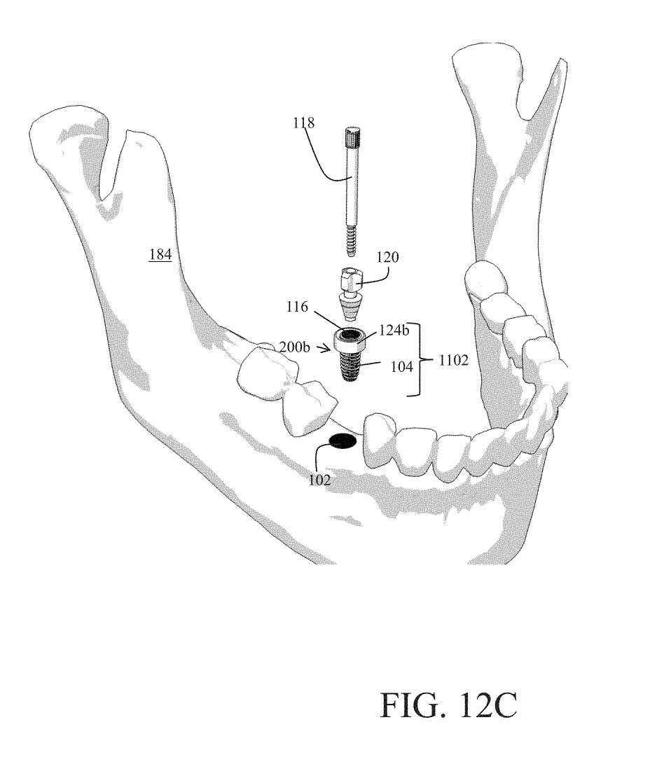

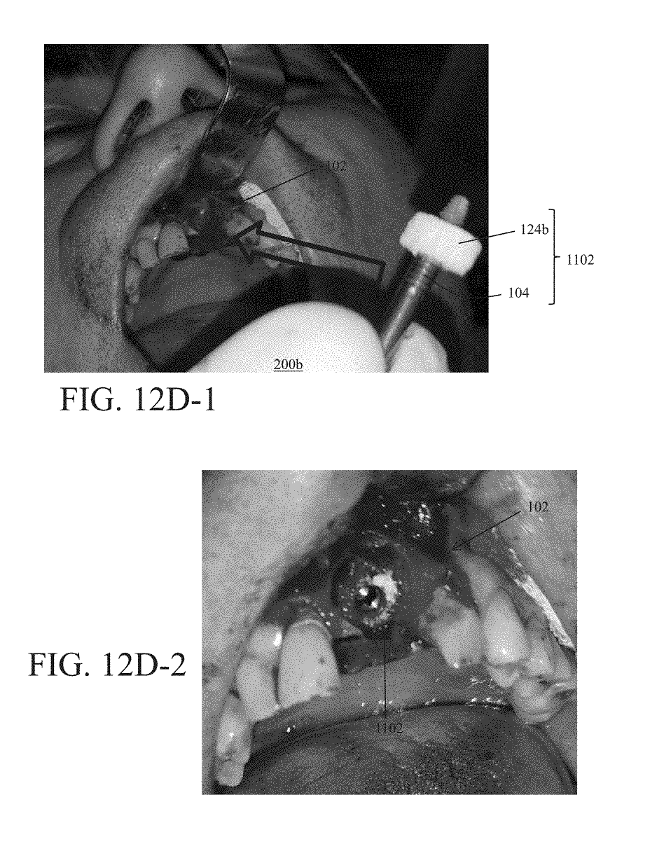

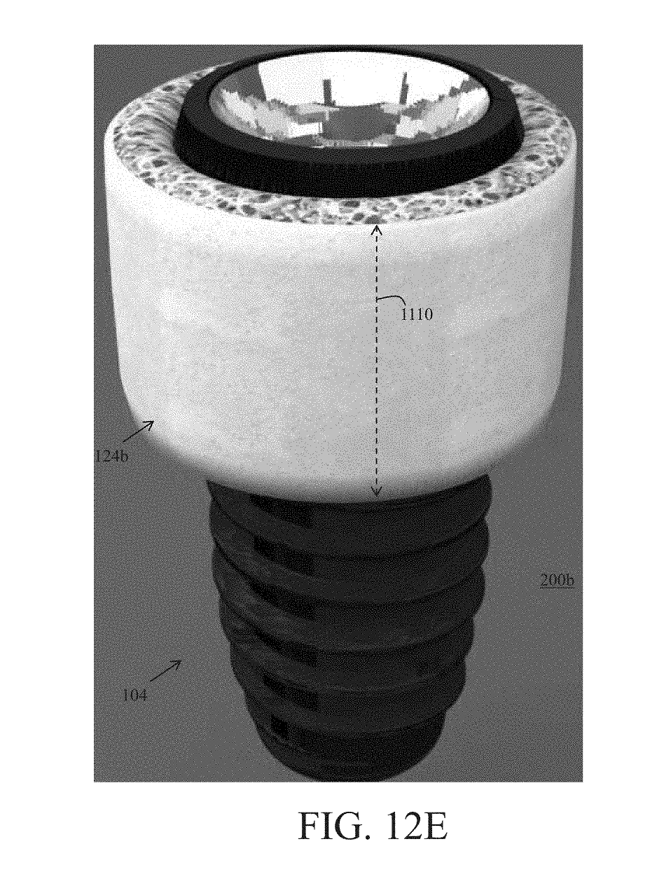

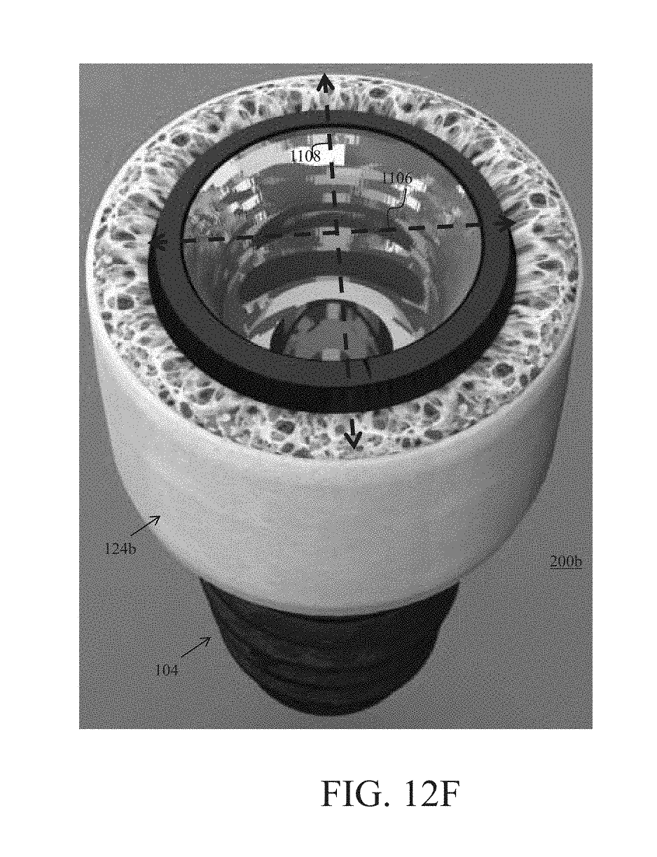

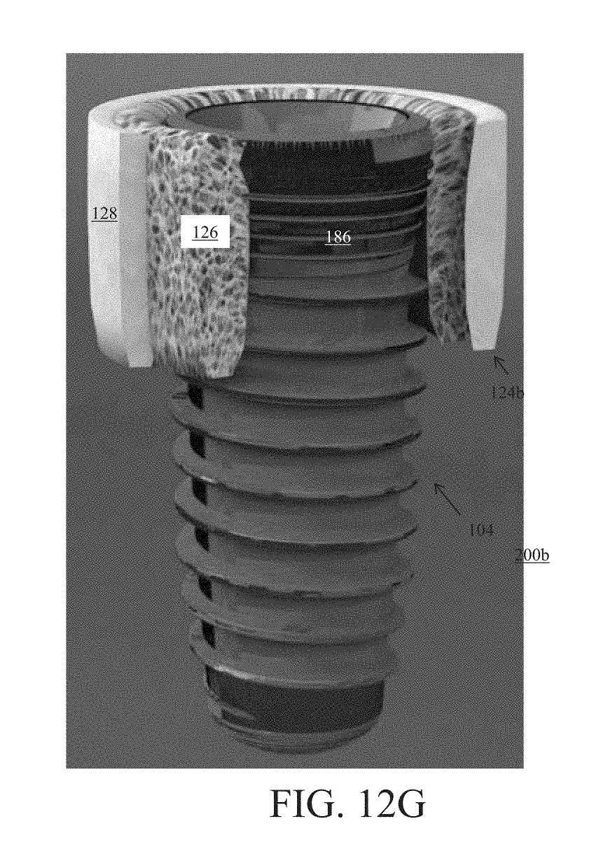

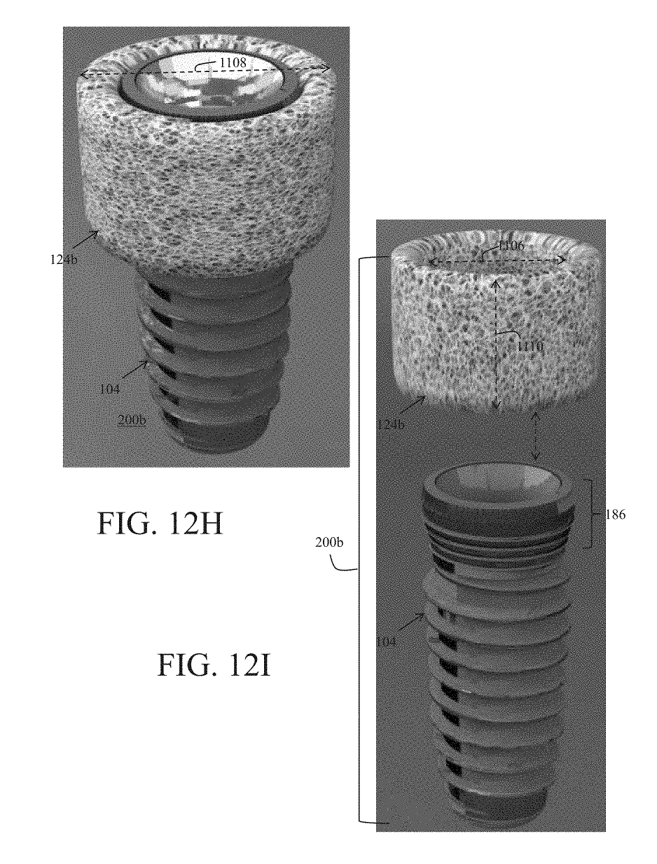

FIGS. 12A to 12I are non-limiting, exemplary illustrations of an embodiment of a fixation system 200b in accordance with the present invention. Fixation system 200b illustrated in FIGS. 12A to 12I includes similar corresponding or equivalent components, interconnections, functional, and or cooperative relationships as fixation system 200a that are shown in FIGS. 1A to 11, and described above. Therefore, for the sake of brevity, clarity, convenience, and to avoid duplication, the general description of FIGS. 12A to 12I will not repeat every corresponding or equivalent components, interconnections, functional, and or cooperative relationships that has already been described above in relation to fixation system 200a that are shown in FIGS. 1A to 11.

Embodiments of fixation system 200b illustrated in FIGS. 12A to 12I do not require a fixation plate 100, but use a fixation facilitator 124. FIGS. 12A to 12I are non-limiting, exemplary overview illustrations of one or more embodiments of a fixation system 200b of the present invention with one or more conventional intraosseous dental implant fixtures 104, exemplarily illustrating universal applicability of one or more embodiments of the present invention at an implantation site on a jawbone 184 (mandible or the maxilla). In particular, FIGS. 12A to 12D-2 are non-limiting, non-exhaustive, exemplary illustrations of various intraosseous dental implant procedures that may be practiced in accordance with one or more embodiments of the apparatus of the present invention.

As illustrated in FIGS. 12A to 12D-2, any known intraosseous dental implant procedure may be continued to be practiced using fixation system 200b. That is, once fixation system 200b illustrated in FIGS. 12A to 12I are associated with implantation site 102, the remaining operational procedures for intraosseous dental implant 104 may be practiced in any well-known and conventional manner. As detailed below, fixation system 200b is comprised of prefabricated intraosseous dental implant fixture assembly 1102, comprising a fixation facilitator 124b (bone growth promoting member) and a conventional intraosseous dental implant fixture 104.

FIG. 12A is a non-limiting exemplary illustration of an intraosseous dental implant procedure that uses abutments 108 along with clinical fasteners 110 to associate a prosthetic tooth 112 with implant fixtures 104 that includes a mounted fixation facilitator 124b, with fixture 104 and fixation facilitator 124b previously secured within implantation site 102 of jawbone 184.

As another example, FIG. 12B is a non-limiting exemplary illustration of an intraosseous dental implant procedure that does not use abutments 108, instead using a healing fastener 114 that are commonly used in most intraosseous dental implant procedures. As illustrated, healing fasteners 114 temporarily close off an axial opening 116 of fixture 104 to block and prevent food or other material from entering inside the fixture's opening 116 while allowing the gingiva or the gum to heal prior to further work.

As yet another example, FIG. 12C is a non-limiting exemplary illustration of an intraosseous dental implant procedure that uses an impression coping components, comprised of fastener 118 and impression coping analog 120, for generating a mold of a prosthetic tooth 112 to be associated with fixture 104. FIGS. 12D-1 and 12D-2 are non-limiting, exemplary illustrations, progressively illustrating a non-limiting, exemplary procedure of implanting fixation system 200a within jawbone 184 at implant site 102.

As illustrated in FIGS. 12A to 12I, once fixation facilitators 124b are mounted onto fixtures 104, and with both associated with the desired implantation site 102 in accordance with one or more embodiments of the present invention, the remaining operational procedures for intraosseous dental implant may be practiced in well-known and conventional manner. Accordingly, fixations system 200b in accordance with one or more embodiments of the present invention may be used with various well known intraosseous dental implant procedures.

As illustrated, prefabricated intraosseous dental implant fixture assembly (graft integrated implant) 1102 is comprised of conventional intraosseous dental implant fixture 104 and fixation facilitator 124b mechanically secured onto intraosseous dental implant fixture 104.

Intraosseous dental implant fixture assembly 1102 may be used in any location where a fixation plate 100 is used or fixation plate 100 is not required or needed, but enhanced ossiointegration is necessary. For example, implant site 102 may be thin, but still have a long bone structure where most of the length of intraosseous dental implant fixture 104 may be used, but the thin structure necessitates additional bone growth promoting member 124b to accommodate the girth (diameter) 146 of intraosseous dental implant fixture 104 for better ossiointegration.

The benefits of using intraosseous dental implant fixture assembly 1102 are reduced potential side effects (e.g., no formation of granulated tissues), resulting in improved ossiointegration rather than resorption, and reduced learning curve (in terms of clinical practice). With the non-limiting, exemplary embodiments illustrated and described in relation to FIGS. 12A to 12I, any dental professional that performs dental implants may continue the same practice (as shown in FIGS. 12A to 12D-2) without requiring specialty skills to handle and mount the above mentioned fixation plates using fasteners to fasten fixation plates, further bending fixation plates, etc. Additional benefit for using intraosseous dental implant fixture assembly 1102 is obtaining bone growth both laterally and vertically (i.e., longitudinal with respect to dental implant axis below and above implant).

As best illustrated in FIGS. 12E to 12I, fixation facilitator 124b covers an upper portion 186 (FIG. 12I) of intraosseous dental implant fixture 104. The final mounting position of fixation facilitator 124b in relation to upper portion 186 of intraosseous dental implant fixture 104 may vary and depends on many factors including for example, the type of the intraosseous dental implant fixture 104 is used (for example, bone level verses tissue level intraosseous dental implant fixtures 104).

As with fixation facilitator 124a (illustrated in FIGS. 1A to 11), fixation facilitator 124b may also comprise of one of cancellous portion 126 or both cancellous 126 and cortical 128 portions, with the cancellous portion 126 of fixation facilitator 124b mechanically secured onto intraosseous dental implant fixture 104. In the exemplary instance illustrated in FIGS. 12E to 12G, fixation facilitator 124b is comprised of both cancellous 126 and cortical 128 portions. FIGS. 12H and 12I illustrate fixation facilitator 124b comprised of cancellous portion 126 of a bone, with the cancellous portion 126 of fixation facilitator 124b mechanically secured onto intraosseous dental implant fixture 104. Fixation facilitator 124b does not require or need reinforcement (e.g., a mesh) but may optionally also include an embedded titanium mesh.

In general, cancellous portion 126 of fixation facilitator 124b is friction fit fastened onto intraosseous dental implant fixture 104, with an inner diameter of 1106 of fixation facilitator 124b expanding for a tight friction fit. As illustrated, fixation facilitator 124b is a hollow cylindrical structure with a bore having inner diameter 1106, an outer diameter 1108 (which defines its thickness (or girth)), and adjustable height 1110.

Cylindrical fixation facilitator 124b may be assembled onto implant by fastening “screwing” the material onto upper threaded portion 186 of implant 104, which may be accomplished by automation or manually. This is similar to a nut being threaded onto a bolt, but herein, fixation facilitator 104 is not threaded, but may be friction fit fastened onto intraosseous dental implant fixture 104. That is, inner diameter 1106 of fixation facilitator 104 expands for a tight friction fit with the slightly longer outer diameter 146 of intraosseous dental implant fixture 104. Therefore, outer diameter 146 of upper portion 186 of intraosseous dental implant fixture 104 is equal to or greater than inner diameter 1106 of fixation facilitator 104. Implant fixture 104 may be screwed into fixation facilitator 124b, and then sterilized, with intraosseous dental implant fixture assembly 1102 applied as an end product on an implant site 102 in well-known manner.

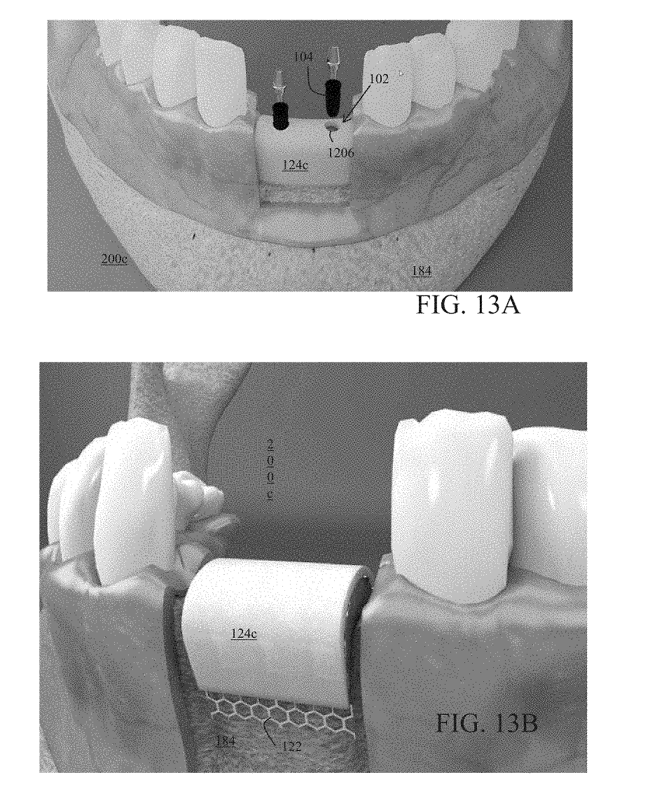

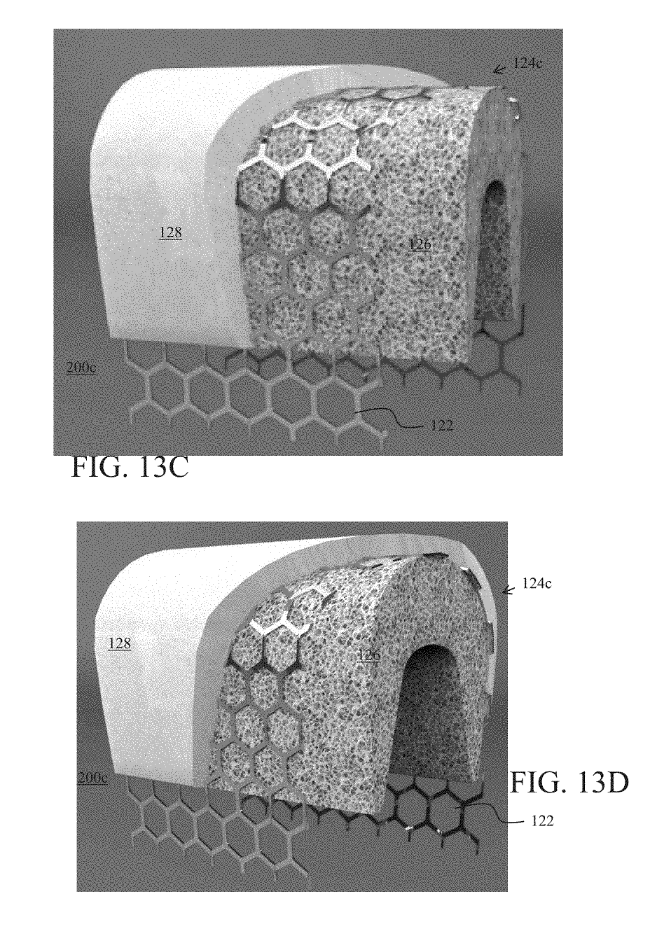

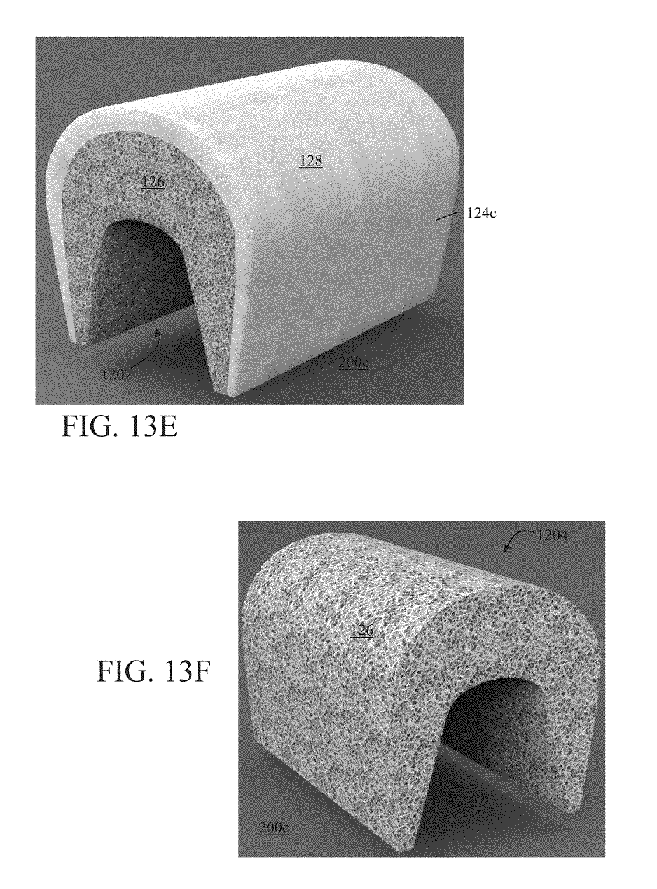

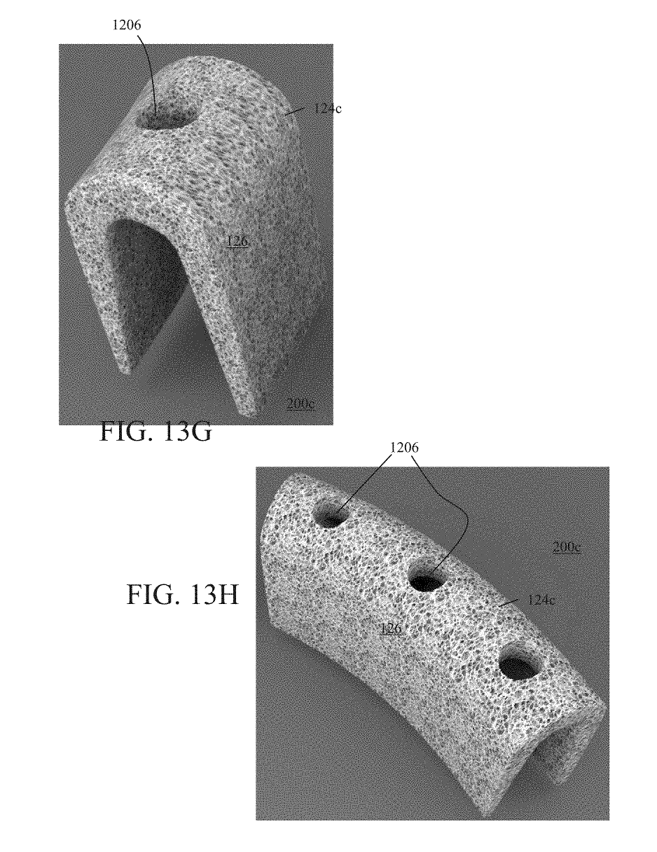

FIGS. 13A to 13H are non-limiting, exemplary illustrations of an embodiment of a fixation system 200c in accordance with the present invention. Fixation system 200c illustrated in FIGS. 13A to 13H includes similar corresponding or equivalent components, interconnections, functional, and or cooperative relationships as fixation system 200a and 200b that are shown in FIGS. 1A to 12I, and described above. Therefore, for the sake of brevity, clarity, convenience, and to avoid duplication, the general description of FIGS. 13A to 13H will not repeat every corresponding or equivalent component, interconnections, functional, and or cooperative relationships that has already been described above in relation to fixation system 200a and 200b that are shown in FIGS. 1A to 12I.

With the above described fixation system 200b (FIGS. 12A to 12I), fixation facilitator 124b is mounted onto intraosseous dental implant fixture 104 and then used as described above whereas with fixation system 200c illustrated in FIGS. 13A to 13H, fixation facilitator 124c is fixed onto implant site 102 by intraosseous dental implant fixture 104. One or more holes 1206 may be drilled through fixation facilitator 124c and aligned with implant sites 102. As with fixation facilitators 124a and 124b, fixation facilitator 124c illustrated in FIGS. 13A to 13H may also comprise of one of cancellous portion 126 only (FIG. 13F to 13H) or both cancellous 126 and cortical 128 portions (FIGS. 13A to 13E), with the cancellous portion 126 of fixation facilitator 124c mechanically secured onto implantation site 102 by intraosseous dental implant fixture 104. Fixation facilitator 124c does not require or need reinforcement (e.g., a mesh) but may optionally also include an embedded titanium mesh 122 (as shown in FIGS. 13B to 13D).

Fixation facilitator 124c assembly may be used to do away with two very complex and time consuming bone grafting procedures—one procedure for obtaining a bone for grafting, and next the actual surgical procedure for grafting the bone, not to mention the time required for healing of the newly grafted bone. With fixation facilitator 124c no procedure is needed for obtaining a bone for grafting, no procedure is need to graft the bone, and further, no extensive wait or healing time is required for implanting intraosseous dental implant fixture 104 by bone growth promoting member 124c.

A critical and advantageous reason for securing fixation facilitator 124c by the intraosseous dental implant fixture 104 onto an implantation site 102 of a jawbone 184 is that intraosseous dental implant fixture 104 provides a complete fixation of the fixation facilitator 124c. This complete fixation prevent micro-movements of fixation facilitator 124c, which enhance osseointegration.

In general, fixation facilitator 124c has an inner configuration (that engages jawbone 184) commensurate with severely reabsorbed bone structure, and an outer configuration commensurate with healthy bone structure. The overall structure of fixation facilitator 124c may comprise of an inner structure 1202 that may comprise of the cancellous bone portion 126, an outer structure 1204 comprised of one of cancellous 126 or cortical 128 bone portions, and an optional embedded reinforcement member 122. Fixation facilitator 124c may be adjusted in terms of its dimensions (by cutting or shaving tools) and implanted at a desired implant site 102 and secured thereon by intraosseous dental implant fixture 104.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

Further the terms “a” and “an” throughout the disclosure (and in particular, claims) do not denote a limitation of quantity, but rather denote the presence of at least one of the referenced item.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A fixation system, comprising:
a fixation plate that includes a first side and a second side;
a hole associated with the fixation plate;
a reinforcement member associated with a hole;
an aperture for securing the fixation plate with a bone;
an orifice for integration of the fixation plate with the bone; and
a fixation facilitator associated with the reinforcement member.

2. The fixation system of claim 1, wherein the fixation plate defines an orifice for integration of the fixation plate with the bone.

3. The fixation system as set forth in claim 1, wherein:
the fixation facilitator is prefabricated, resulting in a prefabricated fixation facilitator.

4. The fixation system as set forth in claim 1, wherein:
the fixation facilitator is a bone growth promoting member.

5. The fixation system as set forth in claim 1, wherein:
the fixation facilitator is a bone growth promoting member that facilitates capillary action as a motive force to move blood from an implant site and gingiva and into the bone growth promoting member for regeneration of bone growth.

6. The fixation system as set forth in claim 4, wherein:
the bone growth promoting member fully covers and encompasses the reinforcement member.

7. The fixation system as set forth in claim 4, wherein:
the reinforcement member is mechanically connected with a perimeter of the hole, and fully embedded within the bone growth promoting member.

8. The fixation system as set forth in claim 4, wherein:
the bone growth promoting member has a generally annular cylindrical body that has a cavity within the body for embedding the reinforcement member.

9. The fixation system as set forth in claim 8, wherein:
the annular cylindrical body has an inner diameter that defines an opening for receiving a device, with the device engaging inner walls of the opening.

10. The fixation system as set forth in claim 4, wherein:
the bone growth promoting member is comprised of one of cancellous portion, cortical portion, or both cancellous and cortical portions, with a reinforcement member embedded within a cavity formed within one of cancellous portion, cortical portion, or both cancellous and cortical portions.

11. The fixation system as set forth in claim 4, wherein:
the bone growth promoting member is a cancellous portion of a bone, with a reinforcement member embedded within a cavity formed within the cancellous portion.

12. The fixation system as set forth in claim 2, wherein:
the reinforcement member is comprised of a mesh.

13. The fixation system as set forth in claim 4, wherein:
the bone growth promoting member is comprised of:
a first piece that is mounted onto a first portion of the reinforcement member extending from a first side of the fixation plate; and
a second piece that is mounted onto a second portion of the reinforcement member extending from a second side of the fixation plate.

14. The fixation system as set forth in claim 13, wherein:
the second piece of the bone growth promoting member is in direct, mechanical contact with an implantation site, and the first piece of the bone growth promoting member is encased by the gingiva.

15. The fixation system as set forth in claim 13, wherein:
the first and the second pieces of the bone growth promoting member facilitate capillary action as a motive force to move blood from an implant site and gingiva and into the bone growth promoting member.

16. A dental implant fixation system, comprising:
a fixation plate that includes a first side and a second side;
a hole defined through the fixation plate;
a reinforcement member associated with the fixation plate proximal to the hole;
an aperture for securing the fixation plate with a bone;
an orifice for integration of the fixation plate with the bone;
a fixation facilitator associated with the reinforcement member; and
an intraosseous dental implant fixture secured to the fixation facilitator.

17. The fixation system as set forth in claim 15, wherein:
the intraosseous dental implant fixture engages with an inner wall of the fixation facilitator, providing a full, mechanical connection between both for ossiointegration.

18. An intraosseous dental implant fixture assembly, comprising:
an intraosseous dental implant fixture; and
a fixation facilitator mechanically secured onto the intraosseous dental implant fixture.

19. The intraosseous dental implant fixture assembly as set forth in claim 18, wherein:
the fixation facilitator covers an upper portion of the intraosseous dental implant fixture.

20. The intraosseous dental implant fixture assembly as set forth in claim 18, wherein:
the fixation facilitator is a bone growth promoting member.

21. The intraosseous dental implant fixture assembly as set forth in claim 20, wherein:
the bone growth promoting member is comprised of one of cancellous portion, cortical portion, or both cancellous and cortical portions, with the cancellous portion of the bone growth promoting member mechanically secured onto the intraosseous dental implant fixture.

22. The intraosseous dental implant fixture assembly as set forth in claim 20, wherein:
the bone growth promoting member is a cancellous portion of a bone, with the cancellous portion of the bone growth promoting member mechanically secured onto the intraosseous dental implant fixture.

23. The intraosseous dental implant fixture assembly as set forth in claim 20, wherein
the cancellous portion of the bone growth promoting member is friction fit fastened onto the intraosseous dental implant fixture, with an inner diameter of the bone growth promoting member expanding for a tight friction fit.

24. The intraosseous dental implant fixture assembly as set forth in claim 20, wherein:
an inner diameter of the bone growth promoting member is smaller than an outer diameter of the intraosseous dental implant fixture, where the bone growth promoting member is mounted; and
an outer diameter of the bone growth promoting member is larger than an inner diameter of an implantation site.

25. A fixation facilitator, comprising:
an inner configuration commensurate with an implantation site of a bone structure, outer configuration commensurate with adjacent sites of the bone structure;
wherein: an intraosseous dental implant fixture secures fixation facilitator onto an implantation site without the use of fasteners.

26. A fixation device adapted for use on a bone, comprising:
a fixation plate that includes a first side and a second side;
a hole through the fixation plate;
an aperture for securing the fixation plate with the bone; and
a fixation facilitator retained within the hole by the fixation plate, whereby the fixation facilitator receives a dental implant.
